(19) United States
(12) Patent Application Publication
(10) Pub. No.: US 2025/0362048 A1
(43) Pub. Date: Nov. 27, 2025

(54) ELECTRONIC DEVICE, METHOD FOR CONTROLLING THE ELECTRONIC DEVICE, AND SYSTEM

(71) Applicant: SAMSUNG ELECTRONICS CO., LTD., Suwon-si (KR)

(72) Inventors: Hangeoroo YOU, Suwon-si (KR); Heechan Kang, Suwon-si (KR); Seungyeon Lee, Suwon-si (KR)

(73) Assignee: SAMSUNG ELECTRONICS CO., LTD., Suwon-si (KR)

(21) Appl. No.: 19/216,207

(22) Filed: May 22, 2025

Related U.S. Application Data
(63) Continuation of application No. PCT/KR2025/005449, filed on Apr. 23, 2025.

(30) Foreign Application Priority Data
May 21, 2024 (KR) 10-2024-0066051

(51) Int. Cl. F24F 11/65; F24F 11/50; F24F 11/74; F24F 11/79; F24F 110/10; F24F 120/14

(52) U.S. Cl. CPC F24F 11/65; F24F 11/50; F24F 11/74; F24F 11/79; F24F 2110/10; F24F 2120/14

(57) ABSTRACT

An electronic device may include: a communication circuit configured to communicate with at least one air conditioner (AC); and at least one processor configured to: obtain map data of an indoor space including a plurality of spaces from at least one of a map generation device or a user device, obtain respective temperature information of each space of the plurality of spaces from at least one of a temperature sensor or the user device, determine a respective priority for temperature adjustment of each space of the plurality of spaces based on an input for activating a temperature customization mode, and control the communication circuit to transmit to the at least one AC a control signal to operate the at least one AC so that, for each space of the plurality of spaces, a temperature is adjusted toward reaching a target temperature based on the respective temperature information that was obtained and the respective priority for temperature adjustment that was determined.

### CROSS-REFERENCE TO RELATED APPLICATIONS

This is a continuation application, under 35 U.S.C. § 111 (a), of International Application No. PCT/KR2025/005449, filed Apr. 23, 2025, which claims priority under 35 U.S.C. § 119 to Korean Patent Application No. 10-2024-0066051, filed May 21, 2024, in the Korean Intellectual Property Office, the disclosures of which are incorporated herein in their entireties by reference.

### TECHNICAL FIELD

The disclosure relates to an electronic device that controls various devices to properly control temperatures of a plurality of spaces, a method for controlling the electronic device, and a system.

### BACKGROUND ART

A single indoor space may include a plurality of spaces. For example, a house may have various spaces, such as multiple rooms, a living room, and a kitchen. An indoor environment may be formed by various devices disposed in a plurality of spaces. For example, at least one air conditioner may be arranged in each of the plurality of spaces.

In an existing technology, IoT devices placed at various positions of an indoor space are used to adjust the temperature and/or humidity of the indoor space. However, the existing technology assumes that sensors (e.g., temperature sensors or humidity sensors) are placed in all of a plurality of spaces in the indoor space, and in a case where information of a specific space is not obtained by a sensor, the information of the specific space may not be provided. In addition, the existing technology does not provide a method for adjusting the temperature and/or humidity of a place where an air conditioner is not located.

### DISCLOSURE

The disclosure provides an electronic device that may provide various modes and control various devices to properly adjust a temperature and humidity of a plurality of spaces to suit a user, a method for controlling the electronic device, and a system.

The disclosure provides an electronic device that may selectively and sequentially control a temperature and humidity of a plurality of spaces according to user settings, a method for controlling the electronic device, and a system.

The disclosure provides an electronic device that, even in a case where temperature information and humidity information of a specific space are not automatically obtained by sensors, may estimate the temperature information and humidity information of the space through questions and answers with a user, a method for controlling the electronic device, and a system.

In accordance with the present disclosure, an electronic device may include: a communication circuit configured to communicate with at least one air conditioner; at least one memory storing instructions; and at least one processor, wherein at least one instruction from among the instructions that, when executed by at least one processor, causes the electronic deviceto: obtain map data of an indoor space including a plurality of spaces from at least one of a map generation device or a user device, obtain respective temperature information of each space of the plurality of spaces from at least one of a temperature sensor or the user device, determine a respective priority for temperature adjustment of each space of the plurality of spaces based on an input for activating a temperature customization mode obtained from the user device, control the communication circuit to transmit to the at least one air conditioner a control signal to operate the at least one air conditioner so that, for each space of the plurality of spaces a temperature of the space is adjusted toward reaching a target temperature for the space based on the respective temperature information for the space and the respective priority for temperature adjustment for the space that was determined.

The at least one instruction from among the instructions that, when executed by the at least one processor, may cause the electronic device further to: based on a failure to obtain the respective temperature information of at least one space of the plurality of spaces, control the communication circuit to transmit notification information indicating an omission of the respective temperature information of the at least one space to the user device.

The at least one instruction from among the instructions that, when executed by the at least one processor, may cause the electronic device further to: based on a failure to obtain the respective temperature information of at least one space of the plurality of spaces, control the communication circuit to transmit a query message requesting a user for a response related to the at least one space to the user device, and based on the response to the transmitted query message, generate the respective temperature information of the at least one space.

The query message may include a request to input a temperature value of the at least one space to the user device, and the at least one instruction from among the instructions that, when executed by the at least one processor, may cause the electronic device further to: based on the temperature value input in response to the request, generate the respective temperature information of the at least one space.

The query message may include a request to input a confirmation of a space adjacent to the at least one space of the plurality of spaces to the user device, and the at least one instruction from among the instructions that, when executed by the at least one processor, may cause the electronic device further to: based on the confirmation of the adjacent space in response to the request and a temperature of the confirmed adjacent space, generate the respective temperature information of the at least one space.

The query message may include a request to input, to the user device, a comparison between a first temperature of a space adjacent to the at least one space of the plurality of spaces and a second temperature felt by the user in the at least one space, and the at least one instruction from among the instructions that, when executed by the at least one processor, may cause the electronic device further to: based on the comparison in response to the request, determine a weight to be added to the first temperature, and generate the respective temperature information of the at least one space based on a sum of the first temperature and the determined weight.

The at least one instruction from among the instructions that, when executed by the at least one processor, may cause the electronic device further to: identify a respective distance between a location of each of the at least one air conditioner and each space of the plurality of spaces in response to the temperature customization mode being activated, and determine the respective priority in ascending order of the respective distance between the location of the each of the at least one air conditioner and each space of the plurality of spaces that was identified.

The at least one instruction from among the instructions that, when executed by the at least one processor, may cause the electronic device further to: identify a respective user activity level in each space of the plurality of spaces based on channel state information obtained in each space of the plurality of spaces in response to the temperature customization mode being activated; and determine the respective priority in descending order of the respective user activity level that was identify.

The at least one instruction from among the instructions that, when executed by the at least one processor, may cause the electronic device further to: identify a space of the plurality of spaces that is designated as a temperature adjustment target in response to the temperature customization mode being activated; and assign a highest priority to the identified space.

The at least one instruction from among the instructions that, when executed by the at least one processor, may cause the electronic device further to: based on a time required for a temperature of one space of the plurality of spaces to reach a target temperature for the one space based on the respective temperature information exceeding a threshold time, control the communication circuit to transmit notification information corresponding to the exceeding of the threshold time to the user device.

The at least one instruction from among the instructions that, when executed by the at least one processor, may cause the electronic device further to: based on a time required for a temperature of one space of the plurality of spaces to reach a target temperature for the one space based on the respective temperature information exceeding a threshold time, control the communication circuit to transmit to the at least one air conditioner a control signal to operate the at least one air conditioner so that a temperature of another space among the plurality of spaces, which has a lower priority than the one space, is adjusted toward reaching a target temperature for the another space.

The at least one instruction from among the instructions that, when executed by the at least one processor, may cause the electronic device further to: based on a respective temperature of each space of the plurality of spaces reaching a respective target temperature for the space based on the respective temperature information, control the communication circuit to transmit to the at least one air conditioner a control signal for controlling at least one of an airflow speed or an airflow direction of the at least one air conditioner.

In accordance with the present disclosure, a method for controlling an electronic device including a communication circuit configured to communicate with at least one air conditioner, and at least one processor, the method may include: by the at least one processor, obtaining map data of an indoor space including a plurality of spaces from at least one of a map generation device or a user device, obtaining respective temperature information of each space of the plurality of spaces from at least one of a temperature sensor or the user device, determining a respective priority for temperature adjustment of each space of the plurality of spaces based on an input for activating a temperature customization mode obtained from the user device, and controlling the communication circuit to transmit to the at least one air conditioner a control signal to operate the at least one air conditioner so that, for each space of the plurality of spaces, a temperature of the space is adjusted toward reaching a target temperature for the space based on the respective temperature information for the space that was obtained and the respective priority for temperature adjustment for the space that was determined.

The method may further include, based on a failure to obtain the respective temperature information of at least one space of the plurality of spaces, controlling the communication circuit to transmit notification information indicating an omission of the respective temperature information of the at least one space to the user device.

The obtaining respective temperature information may include: based on a failure to obtain the respective temperature information of at least one space of the plurality of spaces, controlling the communication circuit to transmit a query message requesting a user for a response related to the at least one space to the user device, and based on the response to the transmitted query message, generating the respective temperature information of the at least one space.

The query message may include a request to input a confirmation of a space adjacent to the at least one space of the plurality of spaces to the user device, and the obtaining respective temperature information may include based on the confirmation of the adjacent space in response to the request and a temperature of the confirmed adjacent space, generating the respective temperature information of the at least one space.

The query message may include a request to input, to the user device, a comparison between a first temperature of a space adjacent to the at least one space of the plurality of spaces and a second temperature felt by the user in the at least one space, and the obtaining respective temperature information may include based on the comparison in response to the request, determining a weight to be added to the first temperature, and generating the respective temperature information of the at least one space based on a sum of the first temperature and the determined weight.

The determining the respective priority for temperature adjustment may include identifying a respective distance between a location of each of the at least one air conditioner and each space of the plurality of spaces in response to the temperature customization mode being activated, and determining the respective priority in ascending order of the respective distance between the location of the each of the at least one air conditioner and each space of the plurality of spaces that was identified.

The determining the respective priority for temperature adjustment may include identifying a respective user activity level in each space of the plurality of spaces based on channel state information obtained in each space of the plurality of spaces in response to the temperature customization mode being activated, and determining the respective priority in descending order of the respective user activity level that was identified.

The controlling the communication circuit may include based on a time required for a temperature of one space of the plurality of spaces to reach a target temperature for the one space based on the respective temperature information exceeding a threshold time, controlling the communication circuit to transmit notification information corresponding to the exceeding of the threshold time to the user device.

According to the disclosure, an electronic device, a method for controlling the same, and a system may provide various modes and control various devices to properly adjust a temperature and humidity of a plurality of indoor spaces to suit a user.

According to the disclosure, an electronic device, a method for controlling the same, and a system may selectively and sequentially control a temperature and humidity of a plurality of spaces according to user settings.

According to the disclosure, even in a case where temperature information and humidity information of a specific space are not automatically obtained by sensors, an electronic device, a method for controlling the same, and a system may estimate temperature information and humidity information of the space through questions and answers with a user.

### DESCRIPTION OF DRAWINGS

FIG. 1 illustrates a system implemented by various electronic devices.

FIG. 2 illustrates an air conditioner according to an embodiment.

FIG. 3 is a control block diagram of a system according to an embodiment.

FIG. 4 is a flowchart illustrating a method for controlling an electronic device according to an embodiment.

FIG. 5 is a flowchart illustrating in more detail a method of obtaining temperature information of the plurality of spaces described in FIG. 4.

FIG. 6 is a flowchart illustrating an example method of determining the priority of each of the plurality of spaces in response to the activation of the temperature customization mode described in FIG. 4.

FIG. 7 is a flowchart illustrating an example method of determining the priority of each of the plurality of spaces in response to the activation of the temperature customization mode described in FIG. 4.

FIG. 8 is a flowchart illustrating an example method of determining the priority of each of the plurality of spaces in response to the activation of the temperature customization mode described in FIG. 4.

FIG. 9 illustrates operations of an electronic device in identifying whether a temperature of each of the plurality of spaces reaches a target temperature.

FIG. 10 illustrates an example of a user interface screen provided via a user device or an air conditioner to control the air conditioner.

FIG. 11 illustrates an example of a user interface screen including sub-menus of the indoor temperature customization settings shown in FIG. 10.

FIG. 12 illustrates an example of a user interface screen including sub-menus of the “home environment information” shown in FIG. 11.

FIG. 13 illustrates an example of a map representing an indoor space and information of the indoor space.

FIG. 14 illustrates an example of a guide message about the modification of the space information shown in FIG. 12.

FIG. 15 illustrates an example of a user interface screen for requesting confirmation of a space adjacent to a specific space in relation to the modification of the space information shown in FIG. 12.

FIG. 16 illustrates an example of a user interface screen for requesting user input of a temperature value and/or a humidity value in relation to the modification of the space information shown in FIG. 12.

FIG. 17 illustrates an example of a user interface screen provided for inputting a temperature value and/or a humidity value according to a user response to the query message in

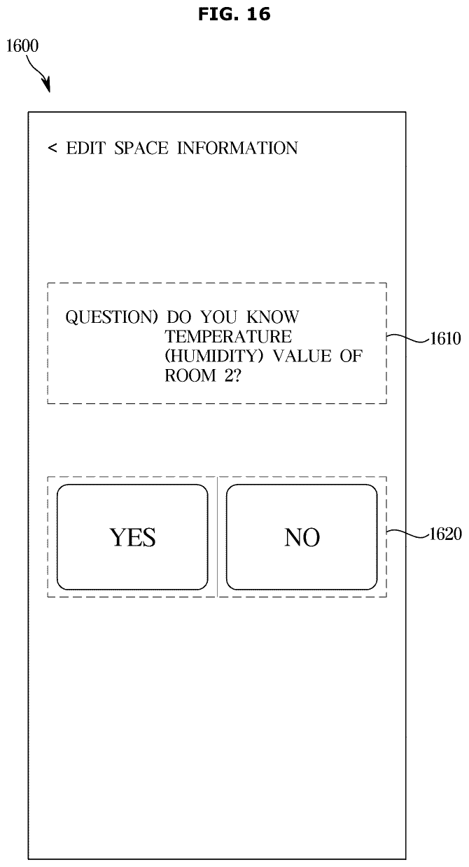

FIG. 16.

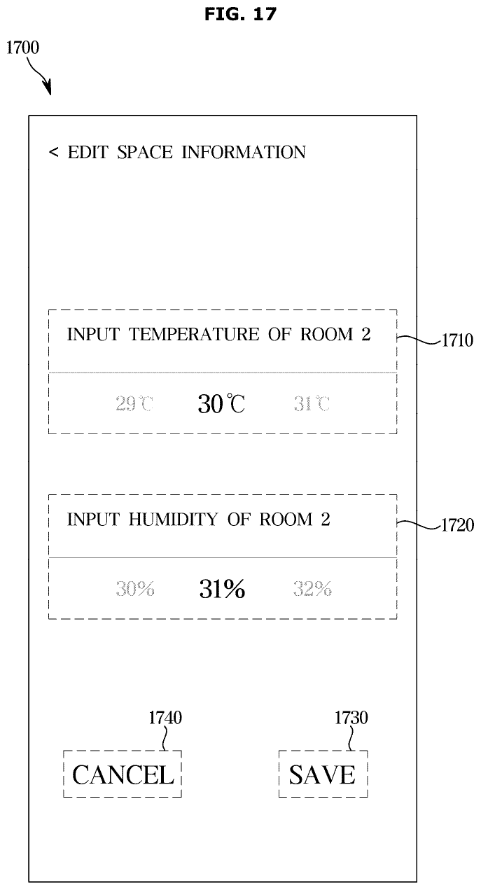

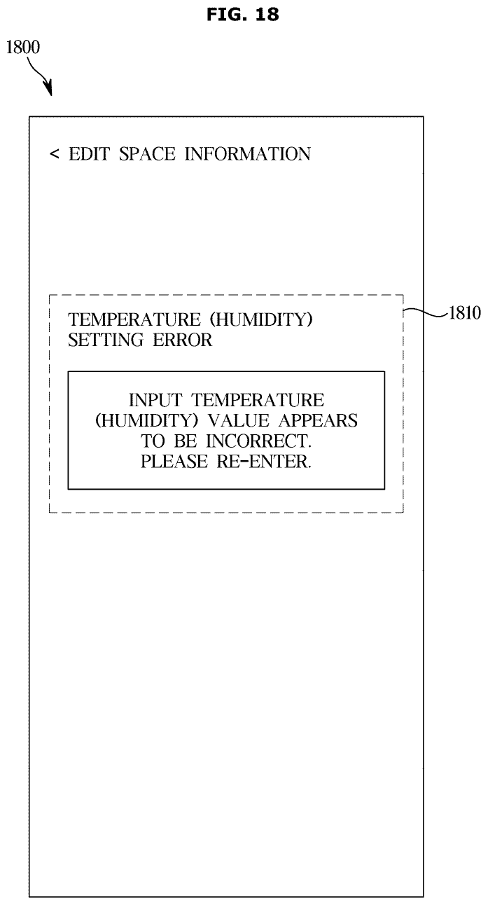

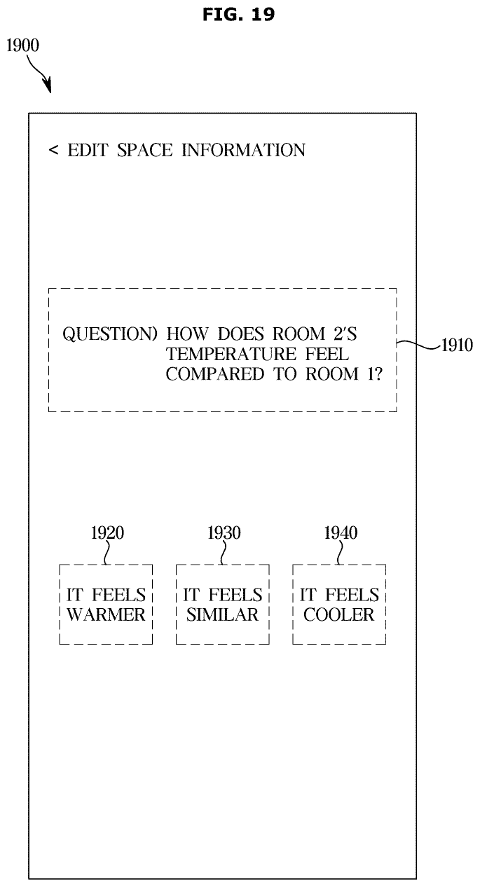

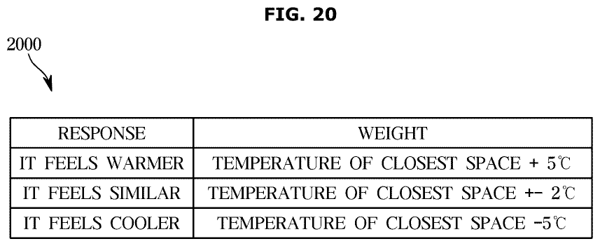

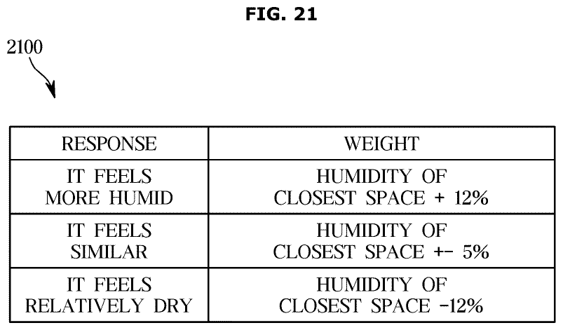

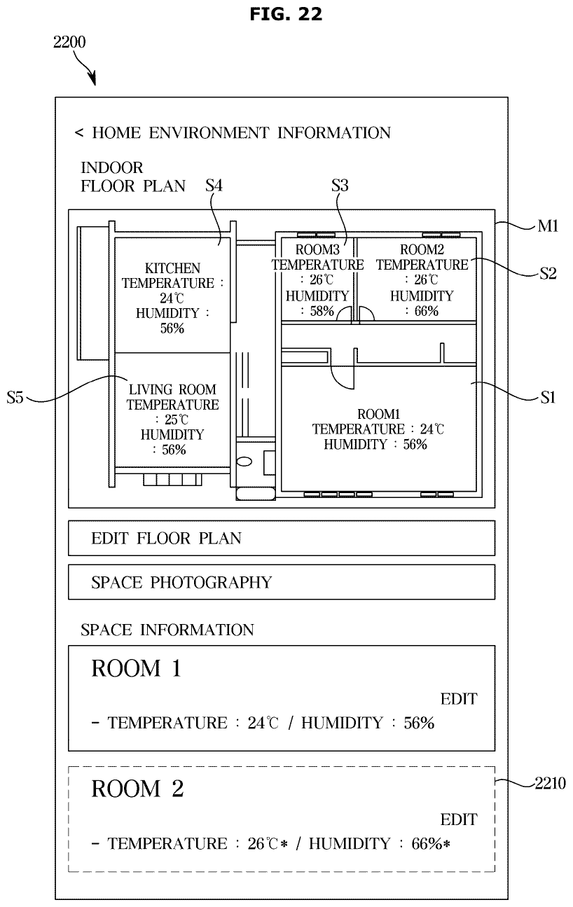

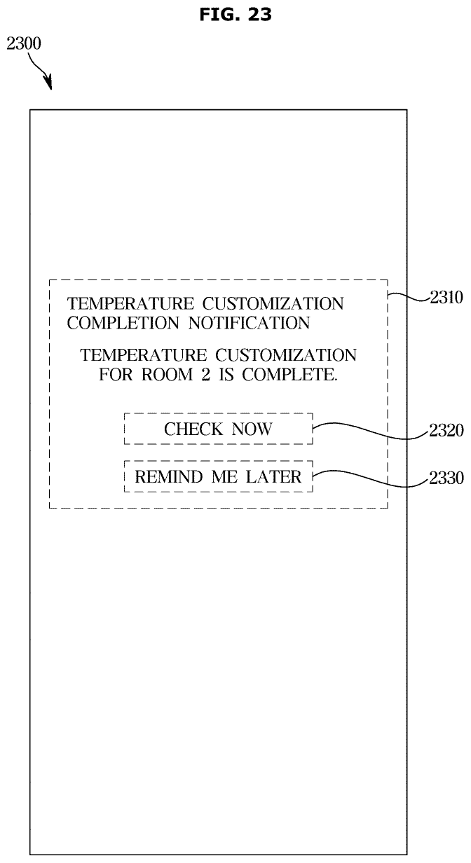

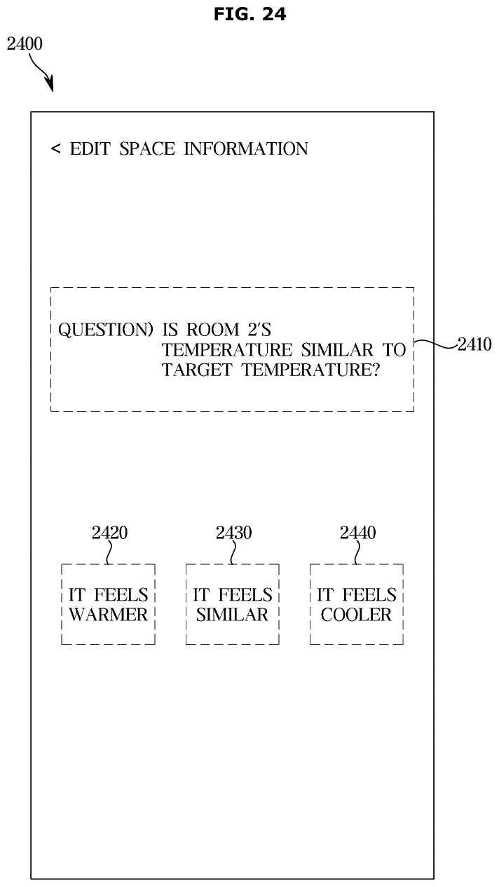

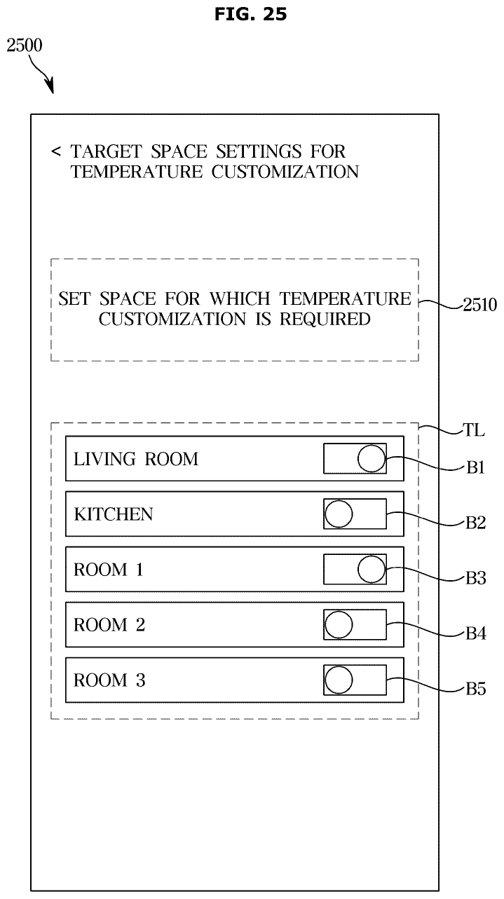

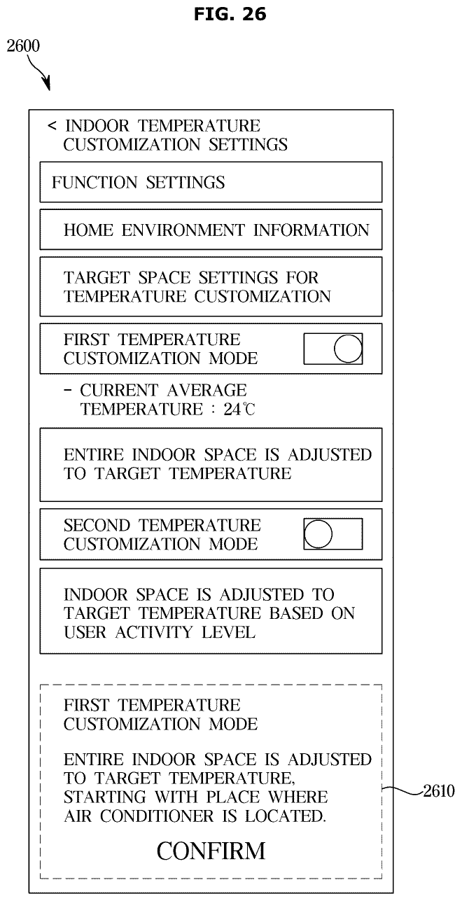

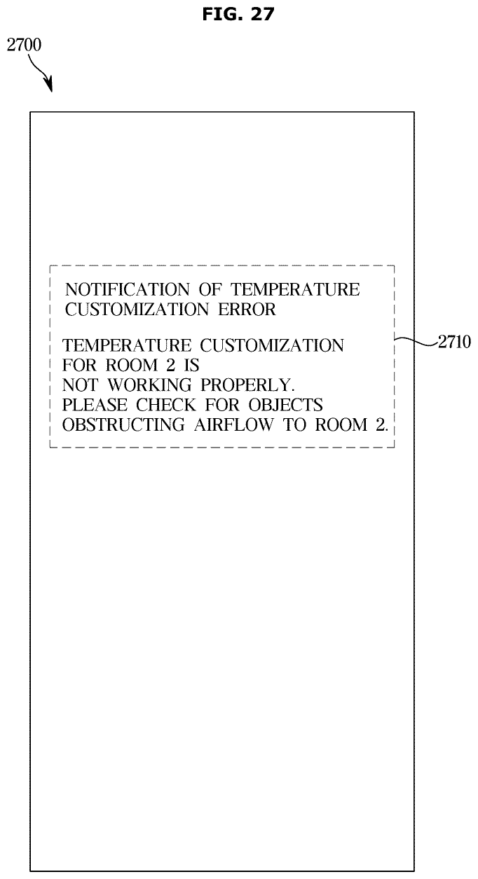

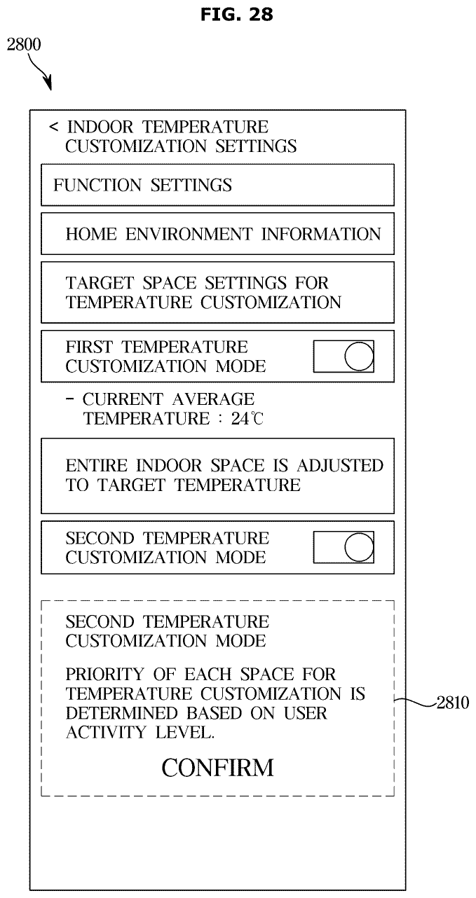

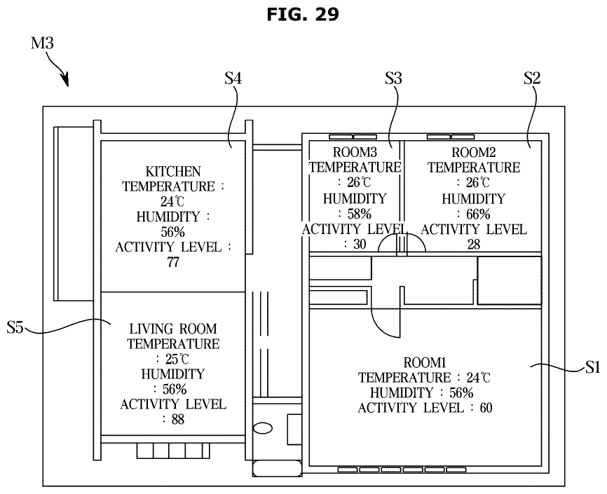

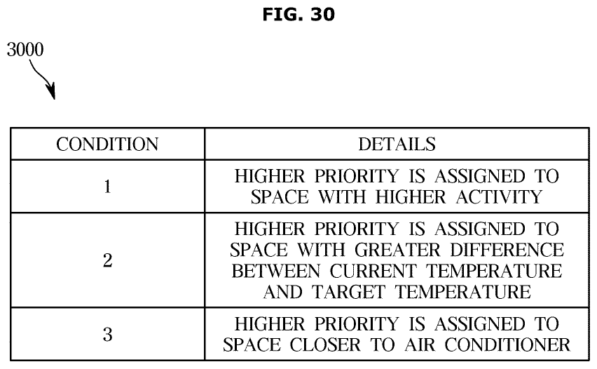

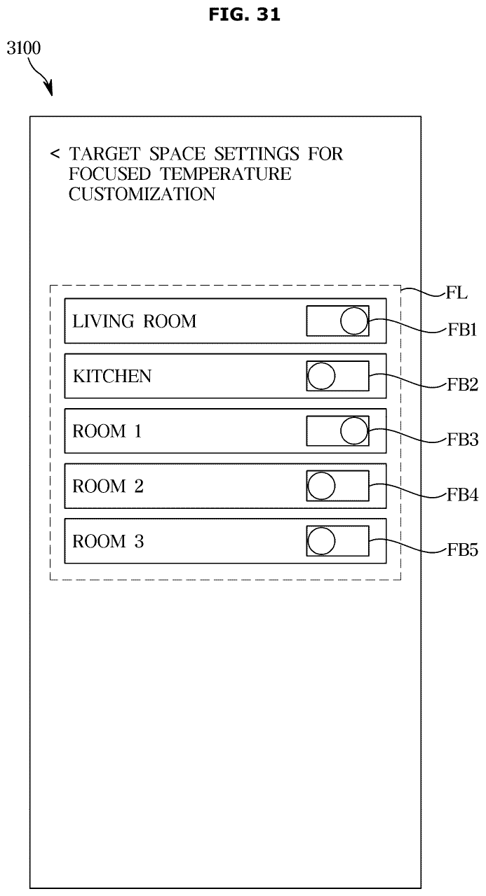

FIG. 18 illustrates an example of a notification message provided in a case where a temperature value and/or a humidity value are input incorrectly in FIG. 17.

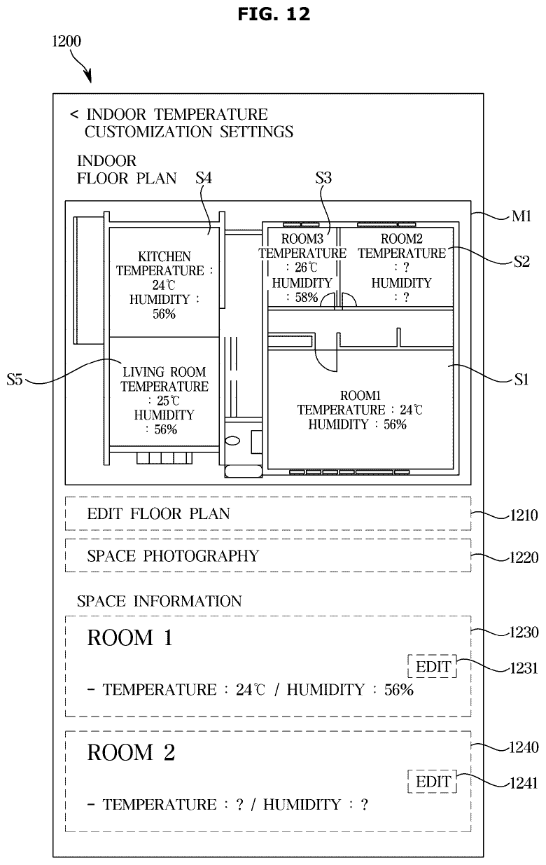

FIG. 19 illustrates an example of a user interface screen for requesting a comparison between a temperature of a specific space and a temperature of an adjacent space, in relation to the modification of the space information shown in FIG. 12.

FIG. 20 is a table illustrating weights added to the temperature of the adjacent space based on a user response to the comparison request described in FIG. 19.

FIG. 21 is a table illustrating weights added to a humidity of an adjacent space based on a user response to a request for comparison between a humidity of a specific space and the adjacent space.

FIG. 22 illustrates a user interface screen, updated from FIG. 12, after information of a specific space is modified.

FIG. 23 illustrates an example of a user interface screen that notifies a user of completion of temperature customization for a specific space and requests feedback on a temperature customization result.

FIG. 24 illustrates an example of a user interface screen for obtaining user feedback on a temperature customization result.

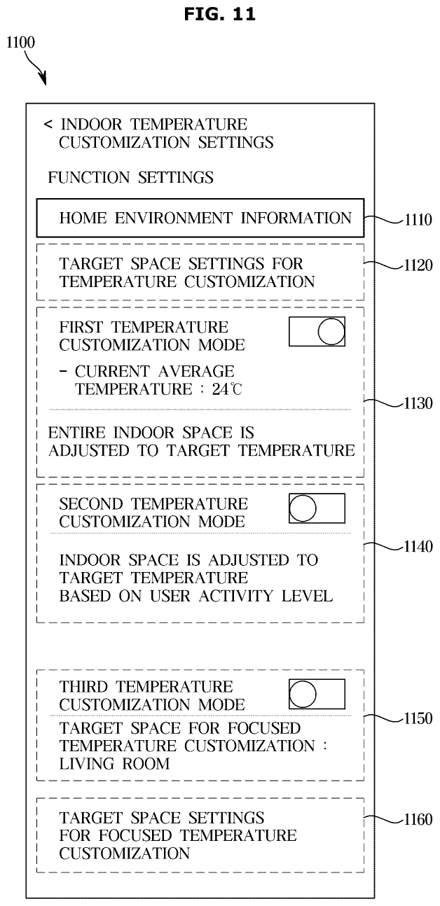

FIG. 25 illustrates an example of a user interface screen for the target space settings for temperature customization shown in FIG. 11.

FIG. 26 illustrates an example of a notification message provided in a case where the first temperature customization mode shown in FIG. 11 is activated.

FIG. 27 illustrates an example of a notification message provided to notify of an error in temperature customization of a specific space.

FIG. 28 illustrates an example of a notification message provided in a case where the second temperature customization mode shown in FIG. 11 is activated.

FIG. 29 illustrates an example of a map provided in a case where the second temperature customization mode shown in FIG. 11 is activated.

FIG. 30 is a table illustrating criteria for assigning priorities to a plurality of spaces in a case where the second temperature customization mode shown in FIG. 11 is activated.

FIG. 31 illustrates an example of a user interface screen provided for the target space settings for focused temperature customization shown in FIG. 11.

### MODES OF THE DISCLOSURE

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

For example, “at least one of A, B, and C” may represent A, B, C, A and B, A and C, B and C, or a combination of A, B, and C.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

As used herein, the term “and/or” includes any and all combinations of one or more of the associated listed items.

Hereinafter, the principles of operation and embodiments of the disclosure will be described with reference to the accompanying drawings.

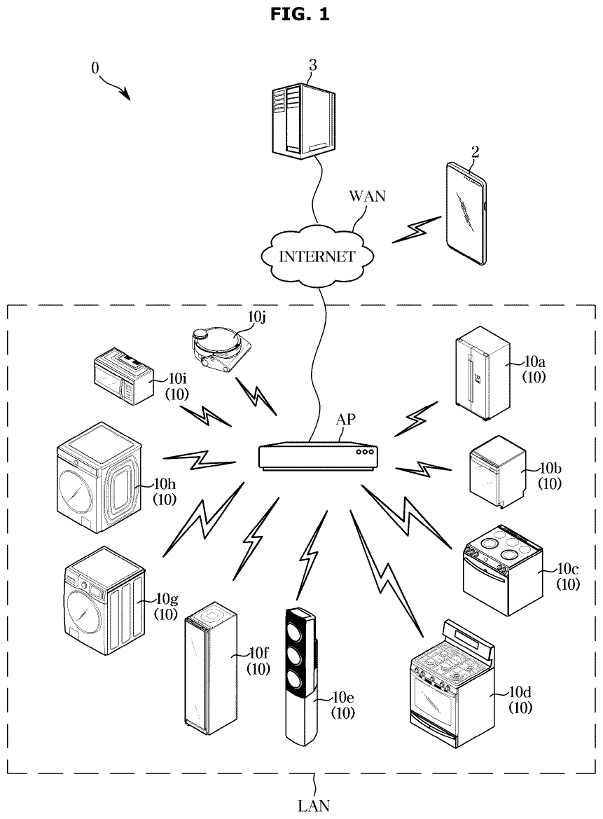

FIG. 1 illustrates a system implemented by various electronic devices.

Referring to FIG. 1, a system 0 according to an embodiment may include a user device 2, a server 3, and a home appliance 10. The user device 2, the server 3, and the home appliance 10 may communicate via a network.

The user device 2 may be carried by a user or placed in the user's home or office, etc. The user device 2 may include, but is not limited to, a personal computer, a terminal, a portable telephone, a smart phone, a handheld device, a wearable device, a display device, and the like.

The server 3 may be implemented as various computing devices, such as a workstation, a cloud, a data drive, a data station, and the like. The server 3 may be implemented as one or more servers physically or logically separated based on a function, detailed configuration of function, or data. The one or more servers may transmit and receive data to each other and process the transmitted and received data.

The home appliance 10 may include a communication interface capable of communicating with another home appliance, the user device 2, or the server 3, a user interface that receives a user input or outputs information to a user, at least one processor that controls an operation of the home appliance 10, and at least one memory that stores a program for controlling the operation of the home appliance 10.

The home appliance 10 may include various types of home appliances. For example, the home appliance 10 may include at least one of a humidifier 10a, a dehumidifier 10b, an air purifier 10c, an electric oven 10d, an air conditioner 10e, a clothes treating apparatus 10f, a washing machine 10g, a dryer 10h, a microwave oven 10i, or a robot cleaner 10j, but is not limited thereto. For example, the aforementioned home appliances are by way of example only, and the home appliance 10 may include various types of appliances not shown in the drawings, such as a vacuum cleaner, a television, and the like.

A network may include both a wired network and a wireless network. The wired network may include a cable network or a telephone network, and the wireless network may include any networks transmitting and receiving a signal via radio waves. The wired network and the wireless network may be interconnected.

The network may include a wide area network (WAN), such as the Internet, a local area network (LAN) formed around an access point (AP), and a short-range wireless network that does not use an AP. The short-range wireless network may include Bluetooth™ (IEEE 802.15.1), Zigbee (IEEE 802.15.4), Wi-Fi Direct, near field communication (NFC), and Z-Wave, but is not limited thereto.

The AP may connect the home appliance 10 or the user device 2 to a WAN connected to the server 3. The home appliance 10 or the user device 2 may be connected to the server 3 via a WAN.

The AP may communicate with the home appliance 10 or the user device 2 using wireless communication, such as Wi-Fi™ (IEEE 802.11), Bluetooth™ (IEEE 802.15.1), Zigbee (IEEE 802.15.4), and the like, and access a WAN using wired communication, but is not limited thereto.

According to various embodiments, the home appliance 10 may be directly connected to the user device 2 or the server 3 without going through an AP. The home appliance 10 may be connected to the user device 2 or the server 3 via a long-range wireless network or a short-range wireless network.

For example, the home appliance 10 may be connected to the user device 2 via a short-range wireless network (e.g., Wi-Fi Direct). In another example, the home appliance 10 may be connected to the user device 2 or the server 3 via a WAN using a long-range wireless network (e.g., a cellular communication interface).

In still another example, the home appliance 10 may access a WAN using wired communication, and may be connected to another home appliance 10 or the server 3 via a WAN. When accessing a WAN using wired communication, the home appliance 10 may also act as an AP.

The home appliance 10 may transmit information about an operation or state to other home appliances, the user device 2, and/or the server 3 via the network. For example, the home appliance 10 may transmit information about an operation or state to other home appliances, the user device 2 or the server 3 upon receiving a request from the server 3, in response to an event in the home appliance 10, or periodically or in real time.

The home appliance 10 may obtain various information from other home appliances, the user device 2, or the server 3, and may provide the obtained information to a user. For example, the home appliance 10 may obtain information related to a function of the home appliance 10 from the server 3 and various environmental information (e.g., weather, temperature, humidity, etc.), and may output the obtained information via a user interface.

The home appliance 10 may operate in accordance with a control command received from other home appliances, the user device 2, or the server 3. For example, the home appliance 10 may operate in accordance with a control command received from the server 3, based on a prior authorization obtained from a user to operate in accordance with the control command of the server 3 even without a user input. Here, the control command received from the server 3 may include a control command input by the user via the user device 2 or a control command based on preset conditions, but is not limited thereto.

The user device 2 may transmit information about a user to the home appliance 10 or the server 3 via the communication interface. For example, the user device 2 may transmit information about a user's location, a user's health condition (i.e., state), a user's preference, a user's schedule, and the like to the server 3. The user device 2 may transmit information about the user to the server 3 based on the user's prior authorization.

The home appliance 10, the user device 2, or the server 3 may use techniques, such as artificial intelligence (AI) to determine a control command. For example, the server 3 may process information about an operation or a state of the home appliance 10 or information about a user of the user device 2 using AI, and transmit a processing result or a control command to the home appliance 10 or the user device 2 based on the processing result.

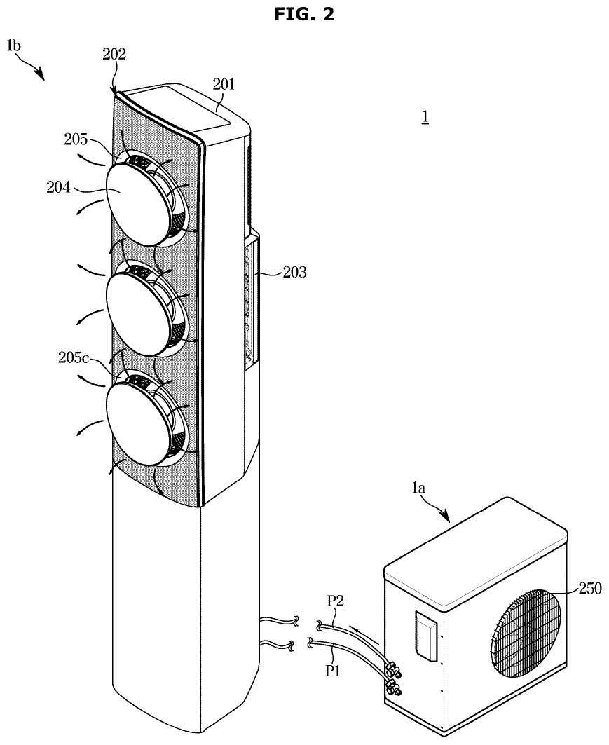

FIG. 2 illustrates an air conditioner according to an embodiment.

An air conditioner 1 shown in FIG. 2 may correspond to the air conditioner 10e of FIG. 1. Referring to FIG. 2, the air conditioner 1 includes an outdoor unit 1a arranged in an outdoor space to perform heat exchange between outdoor air and refrigerant, and an indoor unit 1b arranged in an indoor space to perform heat exchange between indoor air and refrigerant. The outdoor unit 1a may be placed outside an air conditioning space, and the indoor unit 1b may be placed inside the air conditioning space. The air conditioning space refers to a space that is cooled or heated by the air conditioner 1. For example, the outdoor unit 1a may be installed outside a building, and the indoor unit 1b may be installed inside a space separated from the outside by a wall, such as a living room or an office.

The outdoor unit 1a and the indoor unit 1b are connected through external pipes P1 and P2. A refrigerant may circulate through the outdoor unit 1a, the external pipes P1 and P2, and the indoor unit 1b. One end of the external pipe P1 or P2 may be connected to a piping valve arranged on one side of the outdoor unit 1a. In addition, the external pipes P1 and P2 may be connected to a refrigerant pipe arranged inside the outdoor unit 1a and the indoor unit 1b.

The outdoor unit 1a may include a compressor, an outdoor heat exchanger, and an expansion valve. A housing of the outdoor unit 1a may have an outdoor fan 250. By operation of the outdoor fan 250, air may be discharged to the outside of the outdoor unit 1a through an outlet in the housing. The outlet may be provided with a fan guard to protect the outdoor fan 250. The fan guard may cover the outlet and may have a grille or mesh shape.

The indoor unit 1b may include a body case 201 and a front panel 202. In addition, the indoor unit 1b may include at least one outlet 205 formed in the front panel 202, and at least one door 204 to open and close the outlet 205. The outlet 205 and the door 204 may be arranged in an upper portion of the front panel 202.

The outlet 205 is arranged to directly discharge the air heat exchanged by an indoor heat exchanger to the outside, i.e., the outlet 205 may be exposed to the outside of the indoor unit 1b. The door 204 may open or close the outlet 205. When the outlet 205 is opened by movement of the door 204, heat-exchanged air may be discharged through the outlet 205.

The door 204 and the outlet 205 may be provided in an equal number and may be arranged in a one-to-one correspondence. The door 204 may have a shape corresponding to the outlet 205. For example, the outlet 205 and the door 204 may each be circular. The door 204 may be movable between an open position to open the outlet 205 and a closed position to close the outlet 205. The door 204 may move in a forward and backward direction between the open position and the closed position. The door 204 may be moved by a door actuator (not shown).

A fan arranged inside the indoor unit 1b may be disposed in the body case 201 to correspond to the outlet 205. The fan may be provided in a number corresponding to the number of outlets 205. The fan includes a fan motor and may rotate using power generated by the fan motor. In a case where a plurality of fans are provided, each of the indoor fans may be controlled to operate at the same rotation speed or at different rotation speeds.

An air inlet 203 may be disposed at the rear of the body case 201. The air introduced into the air inlet 203 may be heat exchanged in the indoor heat exchanger, and the heat-exchanged air may be discharged to the outside (i.e., an indoor space) of the indoor unit 1b through the outlet 205.

Although the air conditioner 1 has been described as including one outdoor unit 1a and one indoor unit 1b, the air conditioner 1 may include a plurality of outdoor units 1a and a plurality of indoor units 1b. For example, a single outdoor unit 1a may be connected to a plurality of indoor units 1b. In addition, the form of the indoor unit 1b is not limited to what is described above. Any type of indoor unit 1b may be applied as long as the indoor unit 1b is installed in an indoor space and is capable of cooling or heating the indoor space.

Although the indoor unit 1b is exemplified as a stand type, the indoor unit 1b is not limited thereto. The indoor unit 1b may be provided in various forms, such as a wall-mounted type or a ceiling type.

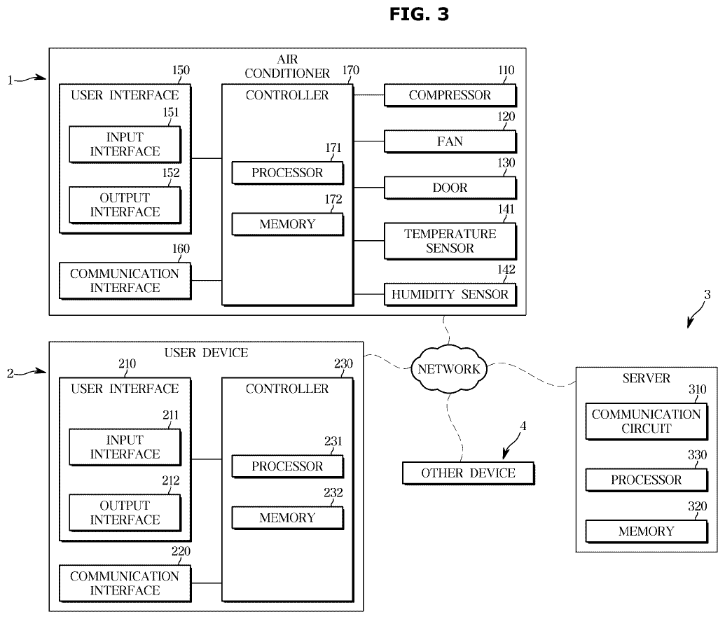

FIG. 3 is a control block diagram of a system according to an embodiment.

Referring to FIG. 3, the air conditioner 1, the user device 2, the server 3, and other devices 4 may communicate with each other via a network. As described above, the system 0 may be implemented by the air conditioner 1, the user device 2, the server 3, and the other devices 4. The air conditioner 1 and the other device 4 may correspond to the home appliance 10 described in FIG. 1.

The air conditioner 1 may include a compressor 110, a fan 120, a door 130, a temperature sensor 141, a humidity sensor 142, a user interface 150, a communication interface 160, and a controller 170. The controller 170 may be electrically connected to various components of the air conditioner 1, including the compressor 110, the fan 120, the door 130, the temperature sensor 141, the humidity sensor 142, the user interface 150, and the communication interface 160, and may control each of the components.

The compressor 110 may compress a gaseous refrigerant and discharge a high-temperature/high-pressure gaseous refrigerant. The compressor 110 may operate by receiving electric energy from an external power source. The compressor 110 includes a compressor motor (not shown), and compresses low-pressure gaseous refrigerant into high-pressure gaseous refrigerant using the rotational force of the compressor motor. An operating frequency of the compressor 110 may be changed to correspond to a capacity required by the indoor unit 1b. The compressor 110 may be an inverter air compressor, a positive displacement compressor, or a dynamic compressor, and various types of compressors that may be considered by a designer may be used.

During a cooling operation, refrigerant discharged from the compressor 110 may release heat through the outdoor heat exchanger and absorb heat through the indoor heat exchanger. During the cooling operation, the outdoor heat exchanger may operate as a condenser that condenses the refrigerant, and the indoor heat exchanger may operate as an evaporator that evaporates the refrigerant. The refrigerant introduced into the indoor heat exchanger may be evaporated by exchanging heat with surrounding air. Accordingly, a temperature of air passing through the indoor heat exchanger may decrease, and the cooled air may be discharged to the outside of the indoor unit 1b. In addition, because the moisture contained in the air passing through the indoor heat exchanger is condensed, the air from which the moisture has been removed may be discharged into the indoor space.

During a heating operation, the refrigerant discharged from the compressor 110 may release heat from the indoor heat exchanger and absorb heat from the outdoor heat exchanger. During the heating operation, the indoor heat exchanger may operate as a condenser that condenses the refrigerant, and the outdoor heat exchanger may operate as an evaporator that evaporates the refrigerant. The high-temperature, high-pressure gaseous refrigerant passing through the indoor heat exchanger exchanges heat with low-temperature, dry air. The refrigerant is condensed into a liquid or near-liquid refrigerant and releases heat, and as the air absorbs the heat, warm air is discharged to the outside of the indoor unit 1b.

The fan 120 may be disposed in the indoor unit 1b. The fan 120 may be positioned around the indoor heat exchanger in the indoor unit 1b and may blow indoor air into the indoor heat exchanger. The fan 120 may blow indoor air before heat exchange to the indoor heat exchanger while simultaneously blowing the heat-exchanged air into the indoor space. The controller 170 may adjust the rotational speed of the fan 120.

The door 130 corresponds to the door 204 described in FIG. 2, and may include a door actuator. Air (wind) generated by operation of the fan 120 may be discharged into the indoor space through an outlet formed by opening the door 130. The door 130 may be opened or closed under control of the controller 170.

The temperature sensor 141 may detect a temperature of air. The temperature sensor 141 may detect at least one of the temperature of air introduced into the indoor unit 1b or the temperature of air discharged from the indoor unit 1b. One or more temperature sensors 141 may be provided. The temperature sensor 141 may transmit an electrical signal and/or temperature data corresponding to the detected air temperature to the controller 170. In addition, the outdoor unit 1a may include a temperature sensor for detecting an outdoor air temperature. The controller 170 may control the temperature sensor 141 to detect air temperature at predetermined time intervals.

The humidity sensor 142 may detect a humidity of air. The humidity sensor 142 may detect at least one of the humidity of air introduced into the indoor unit 1b or the humidity of air discharged from the indoor unit 1b. One or more humidity sensors 142 may be provided. The humidity sensor 142 may transmit an electrical signal and/or humidity data corresponding to the detected air humidity to the controller 170. In addition, the outdoor unit 1a may include a humidity sensor for detecting an outdoor air humidity. The controller 170 may control the humidity sensor 142 to detect air humidity at predetermined time intervals.

The user interface 150 may obtain user input and may output various information. The user interface 150 may include an input interface 151 and an output interface 152. A user may interact with the air conditioner 1 through the user interface 150.

The input interface 151 may obtain user input. The input interface 151 may transmit an electrical signal corresponding to the user input to the controller 170. The user input may include various commands. For example, the input interface 151 may obtain a power-on command, a power-off command, an operation mode setting command, an airflow direction control command, or an airflow speed control command. The user input may also be obtained from the user device 2. The controller 170 may control the air conditioner 1 based on the user input obtained by the input interface 151.

The input interface 151 may include various buttons. For example, the input interface 151 may include a power button to turn the air conditioner 1 on or off, an operation mode setting button to set an operation mode (e.g., cooling, heating, dehumidification) of the air conditioner 1, an airflow direction control button to adjust an airflow direction of the indoor unit 1b, and an airflow speed control button to adjust an airflow speed of the indoor unit 1b. Each button may include a visual indicator (e.g., text, images, icons) that indicates its function.

A “button” may be replaced by a user interface (UI) element, a tact switch, a push switch, a slide switch, a toggle switch, a micro switch, a touch switch, a touch pad, a touch screen, a jog dial, and/or a microphone.

The output interface 152 may be controlled by the controller 170 to output various information related to the operation of the air conditioner 1. For example, the output interface 152 may display various information such as an operation mode and an operation time of the air conditioner 1, a current temperature, or a target temperature. The output interface 152 may output visual and/or audible information.

The output interface 152 may include at least one of a liquid crystal display (LCD) panel, an indicator, a light emitting diode (LED) panel, an organic light emitting diode (OLED) panel, a micro LED panel, or a speaker.

The output interface 152 may display various screens showing information input by a user or information provided to the user. The output interface 152 may display information related to the operation of the air conditioner 1 as text or images. The output interface 152 may display a graphic user interface (GUI) that allows control of the air conditioner 1.

The communication interface 160 may perform wired communication and/or wireless communication with the user device 2, the server 3, and the other device 4. The communication interface 160 may be controlled to transmit data to or receive data from the user device 2, the server 3, and the other device 4.

The communication interface 160 may include at least one of a short-range wireless communication circuit or a long-range wireless communication circuit. The communication interface 160 may establish a direct (e.g., wired) communication channel or a wireless communication channel, and support the performance of the communication through the established communication channel. The communication interface 160 may include a wireless communication circuit (e.g., cellular communication circuit, short-range wireless communication circuit, or global navigation satellite system (GNSS) communication circuit) and/or wired communication circuit (e.g., local area network (LAN) communication circuit or power line communication circuit).

The communication interface 160 may communicate with an external device through a short-range wireless communication network (e.g., Bluetooth, Wi-Fi Direct, or infrared data association (IrDA)) or a long-range wireless communication network (e.g., a legacy cellular network, a 5G network, a next-generation communication network, the Internet, or a computer network (e.g., LAN or WAN).

The short-range wireless communication circuit may include a Bluetooth communication circuit, Bluetooth Low Energy (BLE) communication circuit, near field communication circuit, WLAN (Wi-Fi) communication circuit, and Zigbee communication circuit, IrDA communication circuit, Wi-Fi Direct (WFD) communication circuit, ultrawideband (UWB) communication circuit, Ant+ communication circuit, microwave (uWave) communication circuit, etc., but is not limited thereto.

The long-range wireless communication circuit may include a communication circuit that performs various types of long-range wireless communication, and may include a mobile communication interface. The mobile communication interface transmits and receives radio signals with at least one of a base station, an external terminal, or a server in a mobile communication network.

In addition, the communication interface 160 may communicate with the user device 2, the server 3, and the other device 4 through an access point (AP).

The controller 170 may include a processor 171 controlling operation of the air conditioner 1, and memory 172 storing programs and data for controlling operation of the air conditioner 1.

The processor 171 may include a logic circuit and arithmetic circuit in hardware. The processor 171 may control the electrically connected components of the air conditioner 1 using programs, instructions, and/or data stored in the memory 172 for operating the air conditioner 1. The controller 170 may be implemented as a control circuit including circuit elements such as capacitors, inductors, or resistors. The processor 171 and the memory 172 may be implemented as separate chips or as a single chip. The controller 170 may also include one or more processors and one or more memories.

The processor 171 may include at least one of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator.

The memory 172 may store programs, applications, instructions, and/or data for operating the air conditioner 1 and may store data generated by the processor 171. For example, the memory 172 may store programs, applications, instructions, and/or data for performing cooling, heating, or dehumidification.

The memory 172 may include non-volatile memory, such as read only memory (ROM) or flash memory, for long-term data storage. The memory 172 may include volatile memory, such as static random access memory (SRAM) or dynamic random access memory (DRAM), for temporary storage of data.

The memory 172 may be implemented as memory embedded in the air conditioner 1, or as memory detachable from the air conditioner 1 depending on a data storage use. For example, data for driving the air conditioner 1 may be stored in the memory embedded in the air conditioner 1, while data for extended functions of the air conditioner 1 may be stored in the memory detachable from the air conditioner 1.

The air conditioner 1 may include other components in addition to the above-described components, or may omit some of the above-described components.

The user device 2 may include a user interface 210, a communication interface 220, and a controller 230. The user interface 210 may obtain user input and may output various information. The user interface 210 may include an input interface 211 and an output interface 212. A user may interact with the user device 2 through the user interface 210.

The input interface 211 may obtain user input. The input interface 211 may transmit an electrical signal corresponding to the user input to the controller 230. The user input may include various commands. The controller 230 may control the user device 2 based on the user input obtained by the input interface 211.

For example, the input interface 211 may obtain user input for operating a user interface element (UI element). The UI element may include visual indicators (e.g., text, images, icons). In addition, the input interface 211 may include various buttons, switches, touch pads, or touch screens.

The output interface 212 may be controlled by the controller 230 to output various information. The output interface 212 may output visual and/or audible information. For example, the output interface 212 may output information related to operation and/or state of the air conditioner 1 connected to the user device 2.

The output interface 212 may display various screens showing information input by a user or information provided to the user. The output interface 212 may display information related to operation of the user device 2 in text or images. The output interface 212 may display a graphic user interface (GUI) that allows control of the user device 2.

The output interface 212 may include at least one of a liquid crystal display (LCD) panel, an indicator, a light emitting diode (LED) panel, an organic light emitting diode (OLED) panel, a micro LED panel, or a speaker.

The user device 2 may include the communication interface 220 for communicating with the air conditioner 1, the server 3, and the other device 4. The communication interface 220 may include communication circuits with various communication technologies. The communication interface 220 may be controlled to transmit data to or receive data from the air conditioner 1, the server 3, and the other device 4.

The communication interface 220 may include at least one of a short-range wireless communication circuit or a long-range wireless communication circuit. The communication interface 220 may communicate with an external device through a short-range wireless communication network (e.g., Bluetooth, Wi-Fi Direct, or IrDA) or a long-range wireless communication network (e.g., a legacy cellular network, a 5G network, a next-generation communication network, the Internet, or a computer network (e.g., LAN or WAN).

The short-range wireless communication circuit may include a Bluetooth communication circuit, BLE communication circuit, NFC circuit, Wi-Fi communication circuit, Zigbee communication circuit, IrDA communication circuit, WFD communication circuit, UWB communication circuit, Ant+ communication circuit, or microwave (uWave) communication circuit, but is not limited thereto.

The long-range wireless communication circuit may include a communication circuit that performs various types of long-range communication, and may include a mobile communication interface. The mobile communication interface transmits and receives radio signals with at least one of a base station, an external terminal, or a server in a mobile communication network.

In addition, the communication interface 220 may communicate with the air conditioner 1, the server 3, and the other device 4 through an access point (AP).

The controller 230 may process data received from the air conditioner 1, the server 3, and the other device 4 through the communication interface 220. The controller 230 may control the communication interface 220 to transmit a user input, obtained via the user interface 210, to at least one of the air conditioner 1, the server 3, or the other device 4.

The user device 2 may include the controller 230 controlling operation of the user device 2. The controller 230 may include at least one processor 231 and at least one memory 232. The memory 232 may store programs, instructions, applications, and/or software for controlling an operation of the user device 2.

The memory 232 of the user device 2 may store a program or an application to control at least one of the air conditioner 1 or the other device 4. The application may be sold installed on the user device 2, or may be downloaded from an external server for installation.

The processor 231 may include a logic circuit and arithmetic circuit in hardware. The processor 231 may control the electrically connected components of the user device 2 using programs, instructions, and/or data stored in the memory 232 for operating the user device 2.

The processor 231 may include at least one of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator.

The memory 232 may include non-volatile memory, such as read only memory (ROM) or flash memory, for long-term data storage. The memory 172 may include volatile memory, such as static random access memory (SRAM) or dynamic random access memory (DRAM), for temporary storage of data.

The memory 232 may be implemented as memory embedded in the user device 2, or as memory detachable from the user device 2 depending on a data storage use. For example, data for driving the user device 2 may be stored in the memory embedded in the user device 2, while data for extended functions of the user device 2 may be stored in the memory detachable from the user device 2.

By running the application, the user device 2 may perform various functions. The user device 2 may access the server 3, create a user account, and communicate with the server 3 based on the login user account. The user device 2 may register the air conditioner 1, the user device 2, and the other device 4 with the server 3.

For example, by operating the air conditioner 1 to allow the air conditioner 1 to access the server 3 according to a procedure guided by the application installed on the user device 2, the server 3 may register the air conditioner 1 with the user account by assigning the identification information (e.g., a serial number or a MAC address) of the air conditioner 1 to the corresponding user account. Likewise, the other device 4 may be registered with the user account.

A user may control the air conditioner 1 and the other device 4 through the application installed on the user device 2. For example, by logging into a user account with the application installed on the user device 2, the air conditioner 1 and the other device 4 registered in the user account appears, and by inputting a control command for the air conditioner 1 or the other device 4, the user device 2 may transmit the control command to the air conditioner 1 or the other device 4 through the server 3.

The components of the user device 2 are not limited to the above-described components, and may include additional components. For example, the user device 2 may include a camera for obtaining images.

The server 3 may include a communication circuit 310, memory 320, and a processor 330. The processor 330 may be electrically connected to components of the server 3 and may control the components. One or more communication circuits 310, memories 320, and processors 330 may be provided.

The processor 330 may control the communication circuit 310 to communicate with the air conditioner 1, the user device 2, the other device 4, and another server. Various communication technologies may be applied to the communication circuit 310. The communication circuit 310 may include at least one of a short-range wireless communication circuit or a long-range wireless communication circuit. The communication circuit 310 may communicate with an external device through a short-range wireless communication network (e.g., Bluetooth, Wi-Fi Direct, or IrDA) or a long-range wireless communication network (e.g., a legacy cellular network, a 5G network, a next-generation communication network, the Internet, or a computer network (e.g., LAN or WAN).

The short-range wireless communication circuit may include a Bluetooth communication circuit, BLE communication circuit, NFC circuit, Wi-Fi communication circuit, Zigbee communication circuit, IrDA communication circuit, WFD communication circuit, UWB communication circuit, Ant+ communication circuit, or microwave (uWave) communication circuit, but is not limited thereto.

The long-range wireless communication circuit may include a communication circuit that performs various types of long-range communication and may include a mobile communication interface. The mobile communication interface transmits and receives radio signals with at least one of a base station, an external terminal, or a server over a mobile communication network.

In addition, the communication circuit 310 may communicate with the air conditioner 1, the user device 2, and the other device 4 through an access point (AP).

The processor 330 may process data received from the air conditioner 1, the user device 2, the other device 4, and another server. The memory 320 may store programs for processing data or may store processed data.

The memory 320 may include non-volatile memory, such as read only memory (ROM) or flash memory, for long-term data storage. The memory 320 may include volatile memory, such as SRAM or DRAM for temporary data storage.

The memory 320 may be implemented as memory embedded in the server 3, or as memory detachable from the server 3 depending on a data storage use. For example, data for driving the server 3 may be stored in the memory embedded in the server 3, while data for extended functions of the server 3 may be stored in the memory detachable from the server 3.

The processor 330 may include at least one of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator.

The server 3 may manage a user account and register the air conditioner 1, the user device 2, and the other device 4 in connection with the user account. The server 3 may manage or control the registered air conditioner 1, the user device 2, or the other device 4. For example, a user may access the server 3 through the user device 2 and create a user account. The user account may be identified by an identifier (ID) and password set by the user. The server 3 may register each of the air conditioner 1, the user device 2, and the other device 4 with the user account according to a predetermined procedure. For example, the server 3 may link identification information of the air conditioner 1, the user device 2, and the other device 4 (e.g., a serial number or a MAC address) to the user account to register, manage, and control the air conditioner 1, the user device 2, and the other device 4.

Upon receiving the information about the operation or state from the air conditioner 1, the user device 2, and the other device 4, the server 3 may update the stored information about the operation or state of the air conditioner 1, the user device 2, and the other device 4. The server 3 may transmit the updated information about the operation or state of the air conditioner 1 or the other device 4 to the user device 2 via a network. Here, updating the information may include various operations in which existing information is changed, such as adding new information to the existing information, replacing the existing information with new information, and the like.

The other device 4 may correspond to various home appliances 10 described in FIG. 1. For example, the other device 4 may correspond to the humidifier 10a, the dehumidifier 10b, the air purifier 10c, the electric oven 10d, the air conditioner 10e, the clothes treating apparatus 10f, the washing machine 10g, the dryer 10h, the microwave oven 10i, and/or the robot cleaner 10j.

The other device 4 may include a processor controlling components of the other device 4 for operation of the other device 4. The other device 4 may include memory storing data, programs, software, instructions, and/or applications required for operating the other device 4.

The other device 4 may include a communication interface for communicating with the air conditioner 1, the user device 2, and the server 3. The other device 4 may transmit operation information of the other device 4, data obtained by the operation of the other device 4, and location data of the other device 4 to the air conditioner 1, the user device 2, and the server 3.

The other device 4 may include at least one temperature sensor and at least one humidity sensor installed in various locations of an indoor space. For example, temperature sensors and/or humidity sensors may be installed on a ceiling, a wall, or a window of the indoor space. Each of the temperature sensors and humidity sensors installed in the indoor space may communicate with the air conditioner 1, the user device 2, and the server 3. The other device 4 may include a map generation device that generates map data of the indoor space. For example, the map generation device may correspond to the robot cleaner 10j.

The server 3 may be referred to as an “electronic device.” However, the server 3 is not limited thereto, and “electronic device” may also refer to the air conditioner 1, the user device 2, or the other device 4.

The server 3 may communicate with the map generation device, the temperature sensor, the user device 2, and the air conditioner 1.

The map generation device (e.g., the robot cleaner 10j) may obtain map data of an indoor space including a plurality of spaces by using at least one of various image sensors (e.g., a camera) or non-image sensors (e.g., radar) while moving across the indoor space. The map generation device may generate a map including structural information of the indoor space by using various algorithms such as a simultaneous localization and mapping (SLAM) algorithm.

The map generation device may transmit the obtained indoor space map data to another electronic device (e.g., the server 3). The server 3 may generate a map of the indoor space by processing the map data obtained from the map generation device. The server 3 may transmit the generated map of the indoor space to at least one of the air conditioner 1 or the user device 2.

The server 3 may also obtain map data from the user device 2. For example, the user device 2 may obtain a plurality of images of a plurality of spaces, and may generate map data including structural information of the plurality of spaces by processing the plurality of images. The user device 2 may transmit the plurality of images of the plurality of spaces to the server 3, and in this case, the server 3 may process the plurality of images to generate the map data.

As described above, the air conditioner 1 may include the temperature sensor 141 and the humidity sensor 142, and various temperature sensors and humidity sensors may be installed in different locations of the indoor space. Each of the temperature sensors installed at various locations in the indoor space may transmit the obtained temperature information to the air conditioner 1 or the server 3. Each of the humidity sensors may transmit the obtained humidity information to the air conditioner 1 or the server 3.

An environment (e.g., temperature or humidity) of each of the plurality of spaces in the indoor space may be the same or may differ. For example, in a case where the indoor space includes three rooms, the environment (e.g., temperature or humidity) of each room may be the same or may differ. A temperature of a first room may be different from temperatures of a second room and a third room. A humidity of the first room may be different from the humidity of the second room and the third room.

The server 3 may generate a map of the indoor space including environment information (e.g., temperature information and/or humidity information) of each of the plurality of spaces in the indoor space. The server 3 may provide the map including the temperature information and/or humidity information of each of the plurality of spaces to at least one of the air conditioner 1 or the user device 2. The air conditioner 1 and the user device 2 may each display the map through a user interface.

The user interface 150 of the air conditioner 1 or the user interface 210 of the user device 2 may obtain (receive) a user input for modifying the map of the indoor space. For example, based on the user input, the air conditioner 1 or the user device 2 may modify the structure of the plurality of spaces in the indoor space.

The air conditioner 1 or the user device 2 may modify at least one of temperature information or humidity information of each of the plurality of spaces based on user input. The air conditioner 1 or the user device 2 may transmit the modified map data to the server 3, and the server 3 may update the map of the indoor space based on the modified map data.

Meanwhile, in a case where a temperature sensor or a device including a temperature sensor is not provided in some of the plurality of spaces, temperature information may not be obtained in some space. Based on the failure to obtain temperature information of at least one of the plurality of spaces, the server 3 may transmit notification information indicating an omission of temperature information for the at least one space to the air conditioner 1 or the user device 2. The notification information may be output via the user interface 150 of the air conditioner 1 or the user interface 210 of the user device 2. The notification information may be provided in text, images, or sound.

In addition, based on the failure to obtain temperature information for at least one of the plurality of spaces, the server 3 may transmit a query message for requesting a user response regarding the at least one space to the air conditioner 1 and/or the user device 2. The query message may be output via the user interface 150 of the air conditioner 1 and/or the user interface 210 of the user device 2. The query message may be provided in text, images, or sound. The server 3 may generate temperature information for the at least one space based on the user response to the query message.

For example, the query message may be a first query message, a second query message, or a third query message. The first query message may include a request to input a temperature value for at least one space. The second query message may include a request to confirm a space adjacent to the at least one space of the plurality of spaces. The third query message may include a request to compare a first temperature of the space adjacent to the at least one space and a second temperature felt by a user in the at least one space.

A user may input responses to the first, second, and third query messages by operating the air conditioner 1 or the user device 2. The first, second, and third query messages may be output in a predetermined order through the air conditioner 1 or the user device 2. For example, the first, second, and third query messages may be output sequentially according to the user response. An output order of the first, second, and third query messages may be changed depending on the design. The first query message may be omitted.

The server 3 may obtain a temperature value of the at least one space based on the user response to the first query message. The server 3 may generate temperature information of the at least one space based on the obtained temperature value.

The server 3 may identify the space adjacent to the at least one space based on the user response to the second query message. The server 3 may obtain a temperature of the space adjacent to the at least one space from the temperature sensor, and may generate temperature information for the space based on the temperature of the adjacent space.

The server 3 may determine a weight to be added to the first temperature of the space adjacent to the at least one space based on the user response to the third query message. The server 3 may generate the temperature information of the at least one space based on the sum of the adjacent space's first temperature and the weight.

As such, even in a case where temperature information of some space is not automatically obtained by a sensor, the system 0 according to the disclosure may perform temperature customization for the entire space by estimating temperature information of some space through questions and answers with a user.

Based on a failure to obtain humidity information of at least one of the plurality of spaces, the server 3 may transmit notification information indicating an omission of the humidity information of the at least one space to the air conditioner 1 or the user device 2. The notification information may be output via the user interface 150 of the air conditioner 1 or the user interface 210 of the user device 2.

As in the case of failing to obtain the temperature information, in a case where a humidity sensor or a device including a humidity sensor is not provided in some of the plurality of spaces, humidity information may not be automatically obtained in some space. Based on the failure to obtain humidity information for some of the plurality of spaces, the server 3 may transmit notification information indicating an omission of humidity information to the air conditioner 1 or the user device 2. In addition, the server 3 may transmit a query message for requesting a user response regarding the space in order to determine humidity information of the space to the air conditioner 1 or the user device 2. The server 3 may generate humidity information of the space based on the user response to the query message. The query message may include a request to input a humidity value, a request to confirm a space adjacent to the space, or a request to compare a first humidity of the space adjacent to the space and a second humidity felt by a user in the space.

The air conditioner 1 or the user device 2 may obtain an input for activating a temperature customization mode. The air conditioner 1 or the user device 2 may transmit the obtained activation input for the temperature customization mode to the server 3. Based on the activation input for the temperature customization mode, the server 3 may determine a priority of each of the plurality of spaces for temperature adjustment.

The server 3 may generate a control signal for the air conditioner 1 to allow a temperature of each of the plurality of spaces to reach a preset target temperature based on the temperature information of the plurality of spaces and the priority of each of the plurality of spaces. The control signal for the air conditioner 1 may include setting signals for an operation mode, an airflow direction, and an airflow speed. The server 3 may transmit the generated control signal for the air conditioner 1 to the air conditioner 1. The air conditioner 1 may perform operations to adjust the temperatures of the plurality of spaces based on the control signal transmitted from the server 3.

The server 3 may transmit a control signal to the air conditioner 1 to adjust at least one of airflow speed or airflow direction of the air conditioner 1, based on the temperature of each of the plurality of spaces reaching the target temperature. By properly adjusting at least one of airflow speed or airflow direction of the air conditioner 1 after the temperature of each space reaches the target temperature, the temperature of each space may be maintained at the target temperature. For example, after the temperature of each space reaches the target temperature, the airflow speed of the air conditioner 1 may be changed to the lowest setting.

The system 0 or the air conditioner 1 according to the disclosure may provide various temperature customization modes to properly adjust the temperature and humidity of a plurality of indoor spaces to suit a user. For example, a first temperature customization mode, a second temperature customization mode, and a third temperature customization mode may be provided.

Once the first temperature customization mode is activated through the air conditioner 1 or the user device 2, the server 3 may determine a distance between the air conditioner 1 and each of the plurality of spaces. The server 3 may determine a priority of each of the plurality of spaces in ascending order of distance from the air conditioner 1 (in an order from closest to farthest distance between the air conditioner 1 and each of the plurality of spaces).

In the first temperature customization mode, the server 3 may transmit a control signal to the air conditioner 1 to first bring a temperature of the space closest to the air conditioner 1 to the target temperature. In a case where a temperature of a first space, which is the closest to the air conditioner 1, has reached the target temperature, the server 3 may transmit a control signal to the air conditioner 1 to bring a temperature of a second space, which is the second closest to the air conditioner 1, to the target temperature. The airflow direction and airflow speed of the air conditioner 1 may be adjusted to control the temperature of the second space. After the temperature of the second space reaches the target temperature, the air conditioner 1 may be controlled to adjust a temperature of a third space which is the third closest to the air conditioner 1.

Once the second temperature customization mode is activated through the air conditioner 1 or the user device 2, the server 3 may determine a user activity level in each of the plurality of spaces based on channel state information (CSI) obtained in each of the spaces. The server 3 may determine a priority of each of the plurality of spaces in descending order of the user activity level.

The channel state information is a numerical representation of a channel state between two electronic devices connected wirelessly. The channel state information may include amplitude attenuation and phase shift. In a case where an object (e.g., a person) is located between two electronic devices arranged in a specific space, a wireless signal may be distorted and the channel state information may change. The server 3 may obtain channel state information of a specific space at predetermined time intervals (e.g., every 10 minutes) during a predetermined detection time (e.g., 3 hours), and may determine an average value of the channel state information obtained during the predetermined detection time as a user activity level. The server 3 may determine that a larger average value of channel state information indicates a higher user activity level. In addition, in a case where a user activity level in a specific space is lower than a predetermined threshold or a user activity level is not obtained in a specific space, the server 3 may determine that a user is absent from the space.

In the second temperature customization mode, the server 3 may transmit a control signal to the air conditioner 1 to first bring a temperature of a space with the highest user activity level to the target temperature. In a case where the temperature of a first space with the highest user activity level has reached the target temperature, the server 3 may transmit a control signal to the air conditioner 1 to bring a temperature of a second space with the second-highest user activity level to the target temperature. After the temperature of the second space reaches the target temperature, the air conditioner 1 may be controlled to adjust a temperature of a third space with the third-highest user activity level.

Once the third temperature customization mode is activated through the air conditioner 1 or the user device 2, the server 3 may identify a space designated by a user as a temperature adjustment target. The user may designate the temperature adjustment target space by operating the air conditioner 1 or the user device 2. The server 3 may assign the highest priority to the space designated as the temperature adjustment target. In addition, the server 3 may further consider a distance between the air conditioner 1 and each of the plurality of spaces, along with a user activity level obtained in each of the plurality of spaces, to determine a priority of each of the plurality of spaces.

The server 3 may count the time required to bring a temperature of one space of the plurality of spaces to the target temperature. The server 3 may count the time from the point when the air conditioner 1 starts operating to bring the space's temperature to the target temperature until the space's temperature actually reaches the target temperature.

Based on the time required to bring the temperature of the one space to the target temperature exceeding a threshold time, the server 3 may transmit notification information indicating an error in the temperature adjustment of the space to the air conditioner 1 or the user device 2. The notification information may be output via the user interface 150 of the air conditioner 1 or the user interface 210 of the user device 2. Based on a time required for a temperature of one space of the plurality of spaces to reach a target temperature for the one space based on the respective temperature information exceeding a threshold time, the server 3 may control the communication circuit to transmit to the air conditioner a control signal to operate the air conditioner so that a temperature of another space among the plurality of spaces, which has a lower priority than the one space, is adjusted toward reaching a target temperature for the another space.

Based on the time required to bring a first temperature of a first space of the plurality of spaces to the target temperature exceeding a first threshold time (e.g., 30 minutes), the server 3 may transmit notification information indicating an error in the temperature adjustment of the first space to the air conditioner 1 or the user device 2. In addition, based on the time required to bring the first temperature of the first space to the target temperature exceeding a second threshold time (e.g., 60 minutes), which is longer than the first threshold time, the server 3 may transmit a control signal to the air conditioner 1 to bring a second temperature of a second space, which has the next priority, to the target temperature.

As such, various modes may be provided to properly adjust the temperature and humidity of the plurality of indoor spaces to suit a user, thereby improving user convenience. In addition, efficiency of temperature adjustment may be increased by selectively and sequentially performing temperature customization of the plurality of spaces.

Various operations of the server 3 are not limited to bringing the temperature of indoor space to the target temperature. The server 3 may also perform the above-described operations to bring an indoor space humidity to a target humidity.

In addition, throughout the specification, various operations described as being performed by the server 3 may be described as being performed by the processor 330 of the server 3. Various operations performed by the server 3 may also be performed by the air conditioner 1 or the user device 2. For example, in a case where a plurality of air conditioners 1 are provided in an indoor space, a main air conditioner may serve as the server 3 and may transmit various control signals to the other air conditioners.

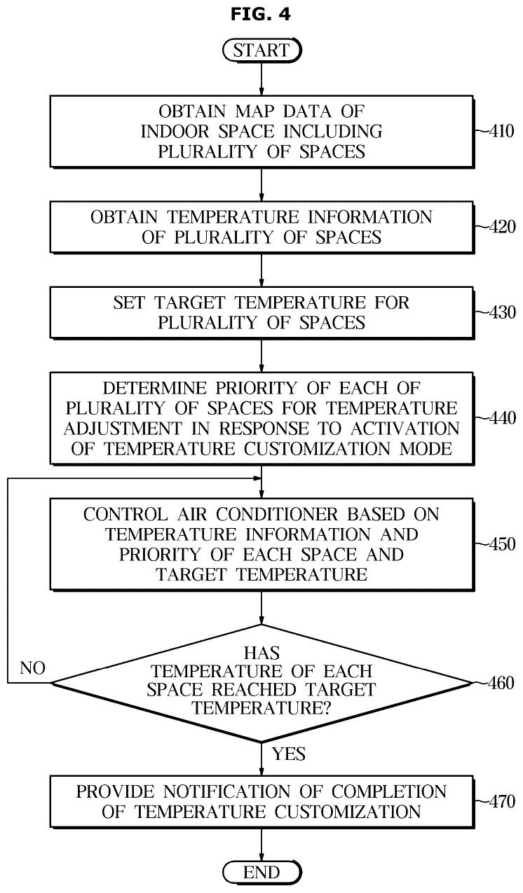

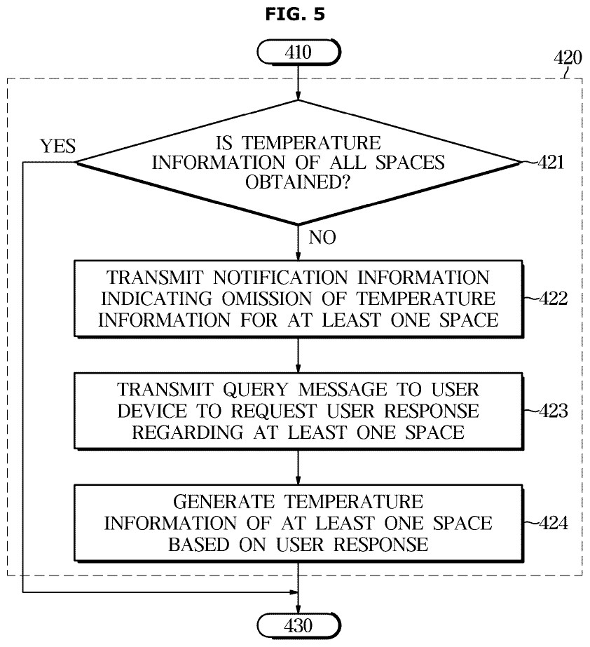

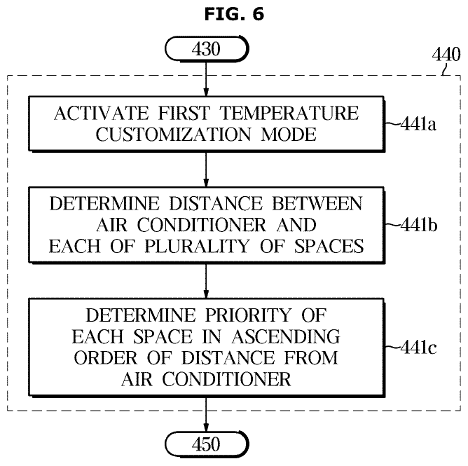

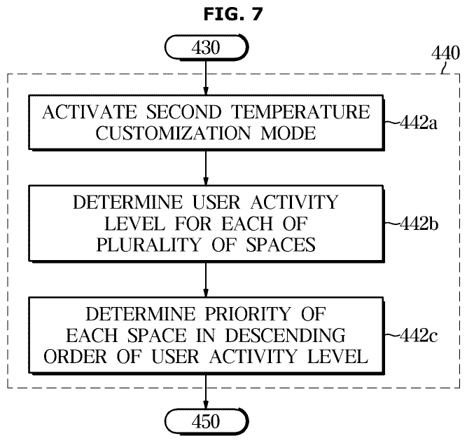

FIG. 4 is a flowchart illustrating a method for controlling an electronic device according to an embodiment.

First, in the specification, the server 3 may be referred to as an “electronic device.” However, the server 3 is not limited thereto, and “electronic device” may also refer to the air conditioner 1, the user device 2, or the other device 4.

Referring to FIG. 4, the processor 330 of the electronic device may obtain map data of an indoor space including a plurality of spaces from at least one of a map generation device or the user device 2 (410). For example, the map generation device may be a robot cleaner, and may obtain map data of the indoor space including the plurality of spaces while moving within the indoor space. The user device 2 may obtain a plurality of images of the plurality of spaces and process the plurality of images to generate map data including structural information of the spaces.

The processor 330 of the electronic device may obtain temperature information of each of the plurality of spaces forming the indoor space (420). The processor 330 of the electronic device may obtain the temperature information of each space from temperature sensors (e.g., the temperature sensor 141 of the air conditioner 1) arranged at various positions in the indoor space. The processor 330 may generate a map of the indoor space including the temperature information of each of the plurality of spaces. The map of the indoor space may be displayed via the user interface 150 of the air conditioner 1 or the user interface 210 of the user device 2. A method of obtaining temperature information of each space is described in more detail in FIG. 5.

The processor 330 of the electronic device may set a target temperature for the plurality of spaces (430). For example, the processor 330 may set the target temperature for the plurality of spaces based on a target-temperature setting input obtained from the air conditioner 1 or the user device 2. The target temperature may be set for a portion or all of the plurality of spaces.

The processor 330 of the electronic device may obtain an input for activating a temperature customization mode from the air conditioner 1 or the user device 2. The processor 330 may determine a priority of each of the plurality of spaces for temperature adjustment in response to the activation of the temperature customization mode (440). A method of determining a priority of each of the plurality of spaces is described in more detail in FIG. 6 through FIG. 8.

The processor 330 of the electronic device may control the air conditioner 1 based on the temperature information and the determined priority of each of the plurality of spaces (450). The processor 330 may generate a control signal for operating the air conditioner 1 and may control the communication circuit 310 to transmit the control signal to the air conditioner 1. The control signal for the air conditioner 1 may include setting signals for an operation mode, an airflow direction, and an airflow speed.

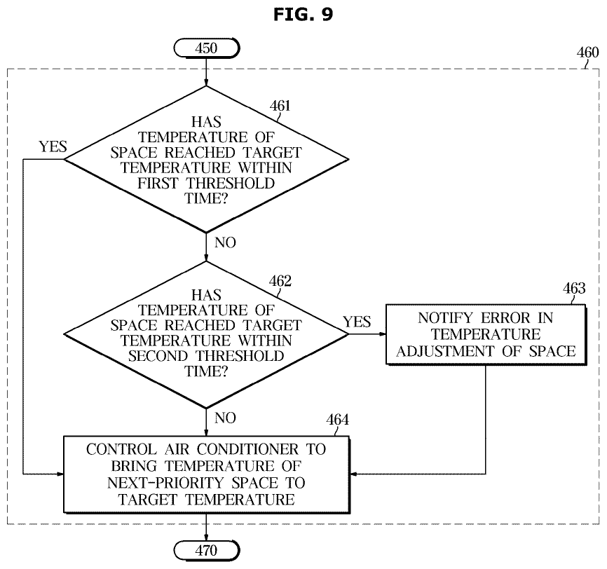

The processor 330 of the electronic device may identify whether a temperature of each of the plurality of spaces has reached the target temperature (460). The processor 330 may obtain temperature information of each space at predetermined time intervals or may obtain a user response to identify whether the temperature of each of the plurality of spaces has reached the target temperature. An operation of the electronic device for identifying whether each space's temperature has reached the target temperature is described in more detail in FIG. 9.

Based on the temperatures of all of the plurality of spaces having reached the target temperature, the processor 330 of the electronic device may provide a notification of completion of temperature customization through the air conditioner 1 or the user device 2 (470). The completion notification may be provided in text, images, or sound.

Based on the temperature of each of the plurality of spaces having reached the target temperature, the processor 330 of the electronic device may transmit a control signal to the air conditioner 1 to adjust at least one of the airflow speed or airflow direction of the air conditioner 1. By properly adjusting at least one of the airflow speed or airflow direction of the air conditioner 1 after the temperature of each space reaches the target temperature, the temperature of each space may be maintained at the target temperature. For example, after a space's temperature reaches the target temperature, the airflow speed of the air conditioner 1 may be set to the lowest level.

FIG. 5 is a flowchart illustrating in more detail a method of obtaining temperature information of the plurality of spaces described in FIG. 4.

Referring to FIG. 5, the processor 330 of the electronic device may identify whether the temperature information of all the plurality of spaces is obtained (421). In a case where a temperature sensor or a device including a temperature sensor is not provided in some of the plurality of spaces, temperature information may not be obtained in some space. In this case, based on the failure to obtain temperature information of at least one of the plurality of spaces, the processor 330 of the electronic device may control the communication circuit 310 to transmit notification information indicating an omission of temperature information for the at least one space to the air conditioner 1 or the user device 2 (422).

Based on the failure to obtain temperature information of the at least one of the plurality of spaces, the processor 330 of the electronic device may transmit a query message for requesting a user response regarding the at least one space to the user device 2 (423). The query message may be transmitted to the air conditioner 1 as well. The query message may be output via the user interface 150 of the air conditioner 1 and/or the user interface 210 of the user device 2. The query message may be provided in text, images, or sound.

For example, the query message may be a first query message, a second query message, or a third query message. The first query message may include a request to input a temperature value for at least one space. The second query message may include a request to confirm a space adjacent to the at least one space of the plurality of spaces. The third query message may include a request to compare a first temperature of the space adjacent to the at least one space and a second temperature felt by a user in the at least one space.

The processor 330 of the electronic device may obtain a user response to the query message from the air conditioner 1 or the user device 2. Based on the user response to the query message, the processor 330 of the electronic device may generate temperature information of the at least one space (424).

The user may input responses to the first, second, and third query messages by operating the air conditioner 1 or the user device 2. The first, second, and third query messages may be output in a predetermined order through the air conditioner 1 or the user device 2. For example, the first, second, and third query messages may be output sequentially according to the user response. An output order of the first, second, and third query messages may be changed depending on the design. The first query message may be omitted.

The processor 330 of the electronic device may obtain a temperature value of the at least one space as the user response to the first query message. The processor 330 may generate temperature information of the at least one space based on the obtained temperature value.

The processor 330 of the electronic device may identify the space adjacent to the at least one space based on the user response to the second query message. The processor 330 may obtain a temperature of the space adjacent to the at least one space from the temperature sensor, and may generate temperature information for the space based on the temperature of the adjacent space.

In addition, once the space adjacent to the at least one space is determined based on the user response to the second query message, the processor 330 of the electronic device may transmit the third query message to the user device 2. The processor 330 may determine a weight to be added to the first temperature of the space adjacent to the at least one space based on the user response to the third query message. The processor 330 may generate the temperature information of the at least one space based on the sum of the adjacent space's first temperature and the weight.

Thus, even in a case where temperature information of some space is not automatically obtained by a sensor, the electronic device according to the disclosure may perform temperature customization for the entire space by estimating temperature information of some space through questions and answers with a user.

FIG. 6 is a flowchart illustrating an example method of determining the priority of each of the plurality of spaces in response to the activation of the temperature customization mode described in FIG. 4.

Referring to FIG. 6, by obtaining the input for activating the first temperature customization mode through the air conditioner 1 or the user device 2, the processor 330 of the electronic device may activate the first temperature customization mode (441a). Activating the first temperature customization mode may refer to turning on the first temperature customization mode.

In response to the activation of the first temperature customization mode, the processor 330 of the electronic device may determine a distance between the air conditioner 1 and each of the plurality of spaces (441b). The processor 330 of the electronic device may determine a priority of each of the plurality of spaces in ascending order of distance from the air conditioner 1 (441c).

In a case where a plurality of air conditioners are installed in different positions, the processor 330 of the electronic device may determine a distance between each of the plurality of air conditioners and each of the plurality of spaces. Accordingly, the priority of each of the plurality of spaces may be different for each of the plurality of air conditioners.

In the first temperature customization mode, the processor 330 of the electronic device may transmit a control signal to the air conditioner 1 to first bring a temperature of the space closest to the air conditioner 1 to the target temperature. In a case where the temperature of a first space, which is closest to the air conditioner 1, has reached the target temperature, the processor 330 may transmit a control signal to the air conditioner 1 to bring a temperature of a second space, which is the second closest to the air conditioner 1, to the target temperature. The airflow direction and airflow speed of the air conditioner 1 may be adjusted to control the temperature of the second space. By the above method, the temperature of each of the plurality of spaces may be brought to the target temperature sequentially.

FIG. 7 is a flowchart illustrating an example method of determining the priority of each of the plurality of spaces in response to the activation of the temperature customization mode described in FIG. 4.

Referring to FIG. 7, by obtaining the input for activating the second temperature customization mode through the air conditioner 1 or the user device 2, the processor 330 of the electronic device may activate the second temperature customization mode (442a). Activating the second temperature customization mode may refer to turning on the second temperature customization mode.

In response to the activation of the second temperature customization mode, the processor 330 of the electronic device may determine a user activity level for each of the plurality of spaces (442b). The processor 330 of the electronic device may determine the user activity level for each of the plurality of spaces by using channel state information (CSI) obtained in each space. The processor 330 of the electronic device may determine that a larger average value of channel state information obtained during a predetermined detection time indicates a higher user activity level. Various methods other than the above-described example may be used to determine the user activity level.

The processor 330 of the electronic device may determine a priority of each of the plurality of spaces in descending order of the user activity level (442c). That is, a space that shows a higher user activity level may be assigned a higher priority.

The processor 330 of the electronic device may transmit a control signal to the air conditioner 1 to first bring a temperature of a space with the highest user activity level to the target temperature. In a case where the temperature of a first space with the highest user activity level has reached the target temperature, the processor 330 may transmit a control signal to the air conditioner 1 to bring a temperature of a second space with the second-highest user activity level to the target temperature. The airflow direction and airflow speed of the air conditioner 1 may be adjusted to control the temperature of the second space. By the above method, the temperature of each of the plurality of spaces may be brought to the target temperature sequentially.

In a case where there is a space for which a user activity level is not obtained or in a case where a plurality of spaces have the same user activity level, the processor 330 of the electronic device may use other determination conditions to determine the priority of each of the plurality of spaces.

For example, the processor 330 of the electronic device may determine the priority of each of the plurality of spaces based on a difference between a current temperature of a space and the target temperature. The greater the difference between the current temperature and the target temperature, the higher the priority assigned to the space.

In addition, the processor 330 of the electronic device may determine the priority of each of the plurality of spaces based on a distance between the air conditioner 1 and each of the plurality of spaces. The closer the distance between the air conditioner 1 and a space, the higher the priority assigned to the space.

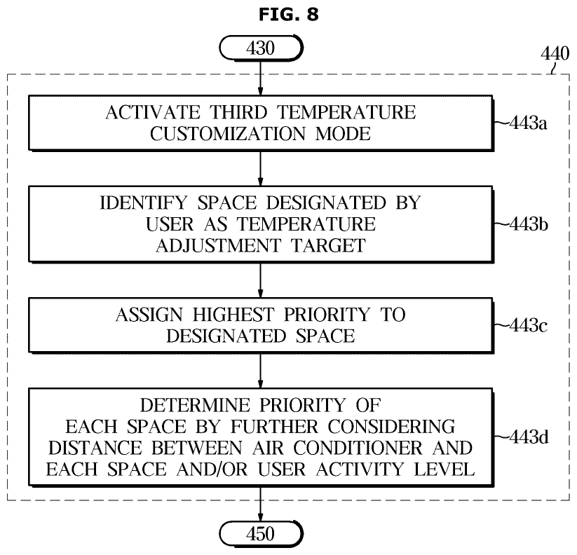

FIG. 8 is a flowchart illustrating an example method of determining the priority of each of the plurality of spaces in response to the activation of the temperature customization mode described in FIG. 4.

Referring to FIG. 8, by obtaining the input for activating the third temperature customization mode through the air conditioner 1 or the user device 2, the processor 330 of the electronic device may activate the third temperature customization mode (443a). Activating the third temperature customization mode may refer to turning on the third temperature customization mode.

In response to the activation of the third temperature customization mode, the processor 330 of the electronic device may identify a space designated by a user as a temperature adjustment target (443b). The user may designate the temperature adjustment target space by operating the air conditioner 1 or the user device 2. The processor 330 of the electronic device may assign the highest priority to the space designated as the temperature adjustment target (443c). In addition, the processor 330 of the electronic device may further consider the distance between the air conditioner 1 and each of the plurality of spaces, along with a user activity level obtained in each of the plurality of spaces, in order to determine the priority of each of the plurality of spaces (443d).

A plurality of spaces may be designated as a temperature adjustment target. In this case, each of the plurality of designated spaces may have a different priority based on a distance between the air conditioner 1 and each designated space and user activity level user activity levels obtained in the designated spaces.

The processor 330 of the electronic device may transmit a control signal to the air conditioner 1 to first bring a temperature of the space designated as the temperature adjustment target to the target temperature. In a case where a temperature of a first space, which is designated as the temperature adjustment target and has the highest priority, has reached the target temperature, the processor 330 may transmit a control signal to the air conditioner 1 to bring a temperature of a second space, which has the next priority, to the target temperature. The airflow direction and airflow speed of the air conditioner 1 may be adjusted to control the temperature of the second space.

FIG. 9 illustrates operations of an electronic device in identifying whether a temperature of each of the plurality of spaces reaches a target temperature.

Referring to FIG. 9, the processor 330 of the electronic device may count the time required to bring a temperature of one space of the plurality of spaces to the target temperature. The processor 330 may count the time from the point when the air conditioner 1 starts operating to bring the space's temperature to the target temperature until the space's temperature actually reaches the target temperature.

The processor 330 may identify whether the temperature of the space has reached the target temperature within a first threshold time (e.g., 30 minutes) after the air conditioner 1 starts operating (461). In a case where the space's temperature has reached the target temperature within the first threshold time, the processor 330 may transmit a control signal to the air conditioner 1 to bring a temperature of the next-priority space to the target temperature (464).

In a case where the space's temperature does not reach the target temperature within the first threshold time, the processor 330 may identify whether the space's temperature has reached the target temperature within a second threshold time (462). The second threshold time (e.g., 60 minutes) may be set longer than the first threshold time. In a case where the space's temperature has reached the target temperature within the second threshold time, the processor 330 may transmit notification information indicating an error in the temperature adjustment of the space to the air conditioner 1 or the user device 2 (463). The processor 330 may then transmit a control signal to bring a temperature of the next-priority space to the target temperature to the air conditioner 1 (464).

In a case where the temperature of the space does not reach the target temperature even within the second threshold time, the processor 330 may transmit a control signal to the air conditioner 1 to bring a temperature of the next-priority space to the target temperature (464). In a case where a temperature of a specific space does not reach the target temperature within the second threshold time, it may be determined that temperature customization for the space is not performed. In the case where the temperature of the space does not reach the target temperature even within the second threshold time, notification information indicating an error in the temperature adjustment of the space may be output via the air conditioner 1 or the user device 2.

Thus, various modes may be provided to properly adjust the temperature and humidity of the plurality of indoor spaces to suit a user, thereby improving user convenience. In addition, efficiency of temperature adjustment may be increased by selectively and sequentially performing temperature customization of the plurality of spaces.

Various operations of the electronic device described with reference to FIG. 4 through FIG. 9 are not limited to bringing the temperature of the indoor space to the target temperature. The electronic device may also perform the above-described operations to bring an indoor space humidity to a target humidity.

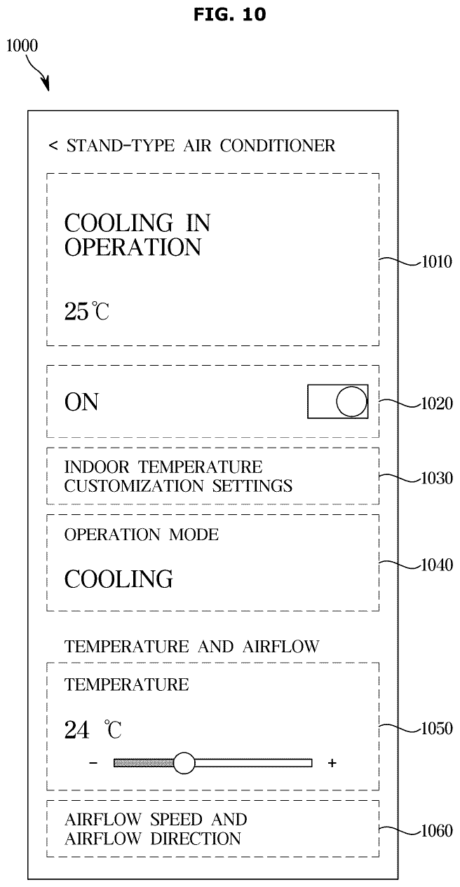

FIG. 10 illustrates an example of a user interface screen provided via a user device or an air conditioner to control the air conditioner.

Referring to a screen 1000 of FIG. 10, a user interface for controlling the air conditioner 1 may be provided by the user device 2. Once an application for controlling the air conditioner 1 is executed in the user device 2, the screen 1000 including various user interface elements related to settings of the air conditioner 1 may be displayed. The screen 1000 of FIG. 10 may be referred to as a “main screen.” The screen 1000 of FIG. 10 may also be displayed via the air conditioner 1.

The application executed by the user device 2 is not limited to controlling only the air conditioner 1. The application may be configured to control various home appliances 10 connected over a network. FIG. 10 illustrates an example of a main screen for controlling a stand-type air conditioner displayed via the user device 2.

For example, the main screen for setting of the air conditioner 1 may include a current state information window 1010 that includes a current operating state of the air conditioner 1 and current temperature information, a power button 1020 for turning the air conditioner 1 on or off, an indoor temperature customization settings menu 1030 for displaying a sub-menu for indoor temperature customization settings, an operation mode setting menu 1040 for selecting an operation mode of the air conditioner 1, a target-temperature setting bar 1050 for setting a target temperature, and an airflow speed and airflow direction setting menu 1060 for setting airflow speed and airflow direction. The air conditioner 1 is currently operating in cooling mode, a current indoor temperature is 25° C., and the target temperature is set to 24° C.

FIG. 11 illustrates an example of a user interface screen including sub-menus of the indoor temperature customization settings shown in FIG. 10.

When a user clicks, touches, or presses the indoor temperature customization settings menu 1030 in the main screen of FIG. 10 through the user device 2, a screen 1100 of FIG. 11, which includes sub-menus for indoor temperature customization settings, may be displayed via the user device 2. The screen 1100 of FIG. 11 may also be displayed via the air conditioner 1. A user input for the indoor temperature customization settings menu 1030 may be obtained through the air conditioner 1 as well.

Referring to FIG. 11, the sub-menus of the indoor temperature customization settings may include a “home environment information” menu 1110 for displaying and modifying indoor space information, a “target space settings for temperature customization” menu 1120 for setting which space is subject to temperature customization among the plurality of spaces that forms the indoor environment, a “first temperature customization mode” menu 1130 for activating or deactivating the first temperature customization mode, a “second temperature customization mode” menu 1140 for activating or deactivating the second temperature customization mode, a “third temperature customization mode” menu 1150 for activating or deactivating the third temperature customization mode, and a “target space settings for focused temperature customization” menu 1160 for setting a space for temperature customization in response to activation of the third temperature customization mode.

FIG. 12 illustrates an example of a user interface screen including sub-menus of the “home environment information” shown in FIG. 11.

In a case where a user input is obtained by clicking, touching, or pressing the “home environment information” menu 1110 shown in FIG. 11 through the air conditioner 1 or the user device 2, a screen 1200 of FIG. 12, which includes various sub-menus related to indoor space information, may be displayed via the user device 2. The screen 1200 of FIG. 12 may also be displayed via the air conditioner 1.

Referring to FIG. 12, the sub-menus of the “home environment information” menu 1110 may include a map M1 displaying an indoor space as a floor plan, a floor-plan edit button 1210 for modifying the map, a space photography button 1220 for executing a camera application of the user device 2 to photograph the indoor space, and information windows 1230 and 1240 for each of the plurality of spaces that form the indoor space.

The map M1 of the indoor space may show a layout including the plurality of spaces and may also show a temperature and humidity of each space. For example, the plurality of spaces may be divided into a first room S1, a second room S2, a third room S3, a kitchen S4, and a living room S5. The map M1 may be displayed as a floor plan that shows the first room S1, the second room S2, the third room S3, the kitchen S4, and the living room S5. In addition, a current temperature and a current humidity of each of the first room S1, the second room S2, the third room S3, the kitchen S4, and the living room S5 may be displayed along with the map M1.

When a user clicks, touches, or presses the floor-plan edit button 1210, a drawing tool for drawing the floor plan may appear. The user may draw the floor plan directly by using the drawing tool.

When a user clicks, touches, or presses the space photography button 1220, the camera application of the user device 2 may be executed. The user device 2 may transmit images of the space, obtained by the camera application, to the server 3. The server 3 may modify the map M1 by processing the images obtained from the user device 2.

Although only the first information window 1230 for the first room S1 and the second information window 1240 for the second room S2 are shown, information windows are not limited thereto. In a case where the user device 2 receives a scroll input from a user, the user device 2 may also display information windows for the third room S3, the kitchen S4, and the living room S5. Each information window of the plurality of spaces may include a current temperature and a current humidity.

An information window of each of the plurality of spaces may include an edit button to modify information (e.g., temperature information, humidity information) of the space. The first information window 1230 may include a first edit button 1231 for modifying temperature information and humidity information of the first room S1. The second information window 1240 may include a second edit button 1241 for modifying temperature information and humidity information of the second room S2.

Meanwhile, the map M1 and the second information window 1240 of the second room S2 each show question marks (?) for the current temperature and current humidity of the second room S2. The question marks indicate that the temperature information and humidity information of the second room S2 are not obtained. In a case where no sensor for obtaining temperature information and humidity information for the second room S2 is installed, or in a case where such a sensor is malfunctioning, the temperature information and the humidity information of the second room S2 may not be obtained automatically. Furthermore, in a case where sensor data is considered to have low reliability, the temperature information and the humidity information of the second room S2 may also be indicated as not obtained. In a case where a rate of change for sensor data, obtained for a predetermined period, deviates from a predetermined range, the server 3 may determine that sensor data has low reliability.

When a user clicks, touches, or presses the second edit button 1241 through the user device 2, a process of modifying the current temperature and humidity of the second room S2 may start. Various methods may be provided to modify information for the second room S2.

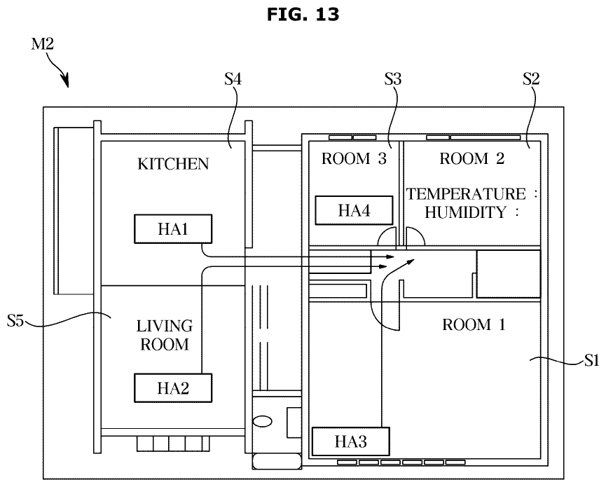

FIG. 13 illustrates an example of a map representing an indoor space and information of the indoor space.

Referring to FIG. 13, a map M2, different from the map M1 of FIG. 12, may be further provided. The map M1 described in FIG. 12 may be referred to as a “first map,” and the map M2 of FIG. 13 may be referred to as a “second map.”

For example, the second map M2 may include a plurality of spaces that form an indoor environment and home appliances disposed in each of the plurality of spaces. In addition, a position of the home appliance in each space may be displayed on the second map M2. In a case where a home appliance is the air conditioner 1, an airflow direction of the air conditioner 1 may also be shown on the second map M2.

In the second map M2, a first home appliance HA1 in the kitchen S4 may be a ceiling-type air conditioner, a second home appliance HA2 in the living room S5 may be a stand-type air conditioner, a third home appliance HA3 in the first room S1 may be a wall-mounted air conditioner, and a fourth home appliance HA4 in the third room S3 may be a dehumidifier. The second room S2 in the second map M2 may show no home appliance.

In addition, an airflow direction of each of the first home appliance HA1, the second home appliance HA2, and the third home appliance HA3 may be shown as arrows. In FIG. 13, it is illustrated that the first home appliance HA1, the second home appliance HA2, and the third home appliance HA3 are operated to bring a temperature of the second room S2 to a target temperature. In order to adjust the temperature of the second room S2, the airflow direction and airflow speed of each of the first home appliance HA1, the second home appliance HA2, and the third home appliance HA3 may be adjusted.

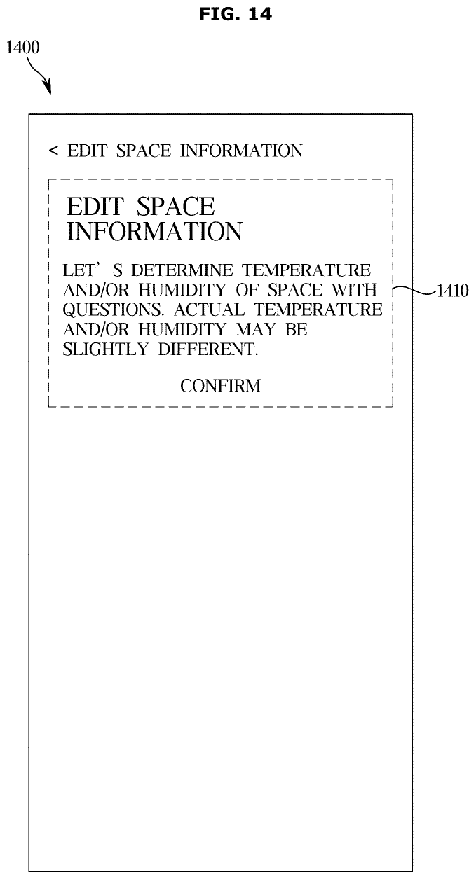

FIG. 14 illustrates an example of a guide message about the modification of the space information shown in FIG. 12.

Referring to FIG. 14, a screen 1400 including a guide message 1410 about modification of space information may be displayed via the user device 2. The screen 1400 of FIG. 14 may also be displayed via the air conditioner 1.

For example, in a case where a user input is made on the second edit button 1241 described in FIG. 12, a guide message indicating a start of a process to modify information of the second room S2 may be provided, as shown in FIG. 14. The guide message may be provided in text, images, or sound. The guide message about the modification of space information may be provided as a pop-up window 1410 including text such as, “let's determine the temperature and/or humidity of the space with a few questions. The actual temperature and/or humidity may be slightly different.”

When a user presses a confirmation button included in the pop-up window 1410 of FIG. 14, the process of modifying the information of the second room S2 may begin. However, the disclosure is not limited thereto. In a case where a user input is made on an edit button for modifying information of a specific space, a process of modifying the space information may be performed without the guide message about modifying space information.

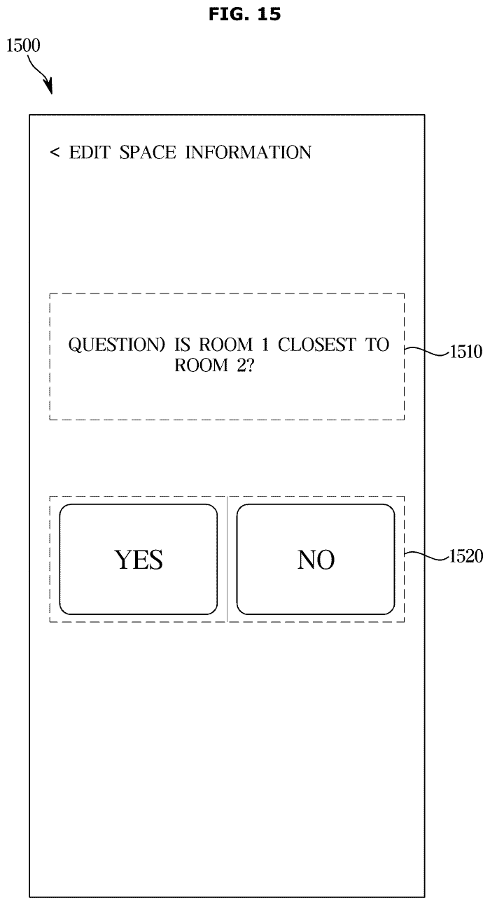

FIG. 15 illustrates an example of a user interface screen for requesting confirmation of a space adjacent to a specific space in relation to the modification of the space information shown in FIG. 12.

Referring to FIG. 15, a screen 1500 including a query message 1510 requesting confirmation about a space adjacent to a specific space (e.g., a space where temperature information has not been obtained) and a button 1520 for entering a user response to the query message 1510 may be output via the air conditioner 1 or the user device 2. The button 1520 may be provided for selectively entering “yes” or “no.” The query message 1510, requesting confirmation of a space adjacent to a specific space, corresponds to the “second query message” described in FIG. 5.

The screen 1500 of FIG. 15 may be displayed in response to the user input (e.g., click, touch, or press) being received through the edit button (refer to FIG. 12) for modifying temperature information and humidity information of a specific space. However, the disclosure is not limited thereto. Even without user input received through the edit button, in a case where the server 3 fails to obtain temperature information (or humidity information) for at least one of the plurality of spaces, the server 3 may control the air conditioner 1 or the user device 2 to output a query message requesting a user response regarding the at least one space.

In a case where the user input is made on the second edit button 1241 for modifying temperature information and humidity information of the second room S2, the user device 2 may display the query message 1510 requesting confirmation of whether the first room S1 is the closest to the second room S2. A user may select “yes” or “no” by clicking, touching, or pressing in order to enter a response to the query message 1510. The user response obtained through the air conditioner 1 or the user device 2 may be delivered to the server 3.

In a case where the user selects “no,” the server 3 may change the query message 1510 to inquire whether another space (e.g., the third room S3, the kitchen S4, or the living room S5) is the closest to the second room S2. In a case where the user selects “yes,” the server 3 may determine that the closest space to the second room S2 is the first room S1.

FIG. 16 illustrates an example of a user interface screen for requesting user input of a temperature value and/or a humidity value in relation to the modification of the space information shown in FIG. 12.

Referring to FIG. 16, a screen 1600, which includes a query message 1610 requesting input of a temperature value and/or a humidity value of at least one space and a button 1620 for entering a user response to the query message 1610, may be provided through the air conditioner 1 or the user device 2. The button 1620 may be provided for selectively entering “yes” or “no.” The query message 1610 that requests confirmation of a space adjacent to a specific space corresponds to the “first query message” described in FIG. 5.

The screen 1600 of FIG. 16 may be displayed in response to the user input (e.g., click, touch, or press) being received through the edit button for modifying temperature information and humidity information of a specific space shown in FIG. 12. However, the disclosure is not limited thereto. Even without user input received through the edit button, in a case where the server 3 fails to obtain temperature information (or humidity information) of at least one of the plurality of spaces, the server 3 may control the air conditioner 1 or the user device 2 to output a query message requesting a user response regarding the at least one space.

For example, in a case where the user input is made on the second edit button 1241 for modifying temperature information and humidity information of the second room S2, the user device 2 may display the query message 1610 requesting input of a temperature value (or humidity value) for the second room S2. The request for a temperature value (or humidity value) may be provided as a question about whether the user knows the temperature (or humidity) of the second room S2. The question about whether the user knows the temperature value and the question about whether the user knows the humidity value may each be presented on separate screens.

The user may select “yes” or “no” by clicking, touching, or pressing in order to enter a response to the query message 1610. The user response obtained through the air conditioner 1 or the user device 2 may be delivered to the server 3.

FIG. 17 illustrates an example of a user interface screen provided for inputting a temperature value and/or a humidity value according to a user response to the query message in FIG. 16.

In FIG. 16, in a case where the user responds “yes” to whether the user knows the temperature value (or humidity value) of the second room S2, the server 3 may control the air conditioner 1 or the user device 2 to display a screen 1700 of FIG. 17 including a user interface element for inputting a temperature value and/or a humidity value. For example, the user interface element for inputting a temperature value and/or a humidity value may include a temperature input window 1710, a humidity input window 1720, a save button 1730, and a cancel button 1740. The temperature input window 1710 and the humidity input window 1720 are displayed together on the single screen 1700, but the windows 1710 and 1720 may be output on separate screens.

A user may input the temperature value of the second room S2 via the temperature input window 1710. For example, the user may select one of the temperature values displayed on the temperature input window 1710 by dragging the temperature input window 1710. The user may input a humidity value of the second room S2 via the humidity input window 1720. For example, the user may select one of the humidity values displayed on the humidity input window 1720 by dragging the humidity input window 1720. When the user presses the save button 1730, the input temperature value and/or humidity value of the second room S2 may be transmitted to and stored in the server 3. When the user presses the cancel button 1740, the temperature value and/or humidity value of the second room S2 are not stored, and the screen 1600 of FIG. 16 may be displayed on the user device 2 again.

FIG. 18 illustrates an example of a notification message provided in a case where a temperature value and/or a humidity value are input incorrectly in FIG. 17.

Referring to FIG. 18, in a case where the temperature value and/or humidity value described in FIG. 17 are entered incorrectly, the air conditioner 1 or the user device 2 may display a screen 1800 including a notification message 1810 indicating an input error for the temperature value and/or the humidity value.

The server 3 may obtain a temperature value for a specific space (e.g., the second room) through the air conditioner 1 or the user device 2. The server 3 may compare the temperature value of the specific space (e.g., the second room) to a temperature of an adjacent space (e.g., the first room). In a case where a difference between the temperature value of the specific space (e.g., the second room) and the temperature of the adjacent space (e.g., the first room) deviates from a predetermined error range, the server 3 may determine that the temperature value for the specific space (e.g., the second room) is entered incorrectly.

The server 3 may transmit a control signal to the air conditioner 1 or the user device 2 to output the notification message 1810 for notifying the user of the input error of the temperature value.

A humidity value input error may be determined by the same method. In a case where a difference between a humidity value of a specific space and a humidity of an adjacent space deviates from a predetermined error range, the humidity value of the specific space may be considered to have been entered incorrectly. In this case, a notification message about the input error of the humidity value may be displayed via the air conditioner 1 or the user device 2.

Meanwhile, a query message (the first query message) including a request to input the temperature value and/or humidity value may not be provided to a user depending on design. In a case where the first query message is omitted, the screens shown in FIG. 16 through FIG. 18 may not be output via the air conditioner 1 or the user device 2.

FIG. 19 illustrates an example of a user interface screen for requesting a comparison between a temperature of a specific space and a temperature of an adjacent space, in relation to the modification of the space information shown in FIG. 12.

Referring to FIG. 19, the air conditioner 1 or the user device 2 may output a query message 1910 requesting a comparison between a temperature of a specific space (e.g., a space where temperature information has not been obtained) and a temperature of a space adjacent to the specific space.

For example, in a case where the user responds “yes” on the screen 1500 of FIG. 15 and the space closest to the second room S2 is determined to be the first room S1, or in a case where the user responds “no” as to whether the user knows the temperature value of the second room S2 on the screen 1600 of FIG. 16, the server 3 may control the air conditioner 1 or the user device 2 to display a screen 1900 of FIG. 19. The query message 1910 shown in FIG. 19 corresponds to the “third query message” described above. The request to compare the temperatures of the two spaces may be provided as a question such as, “how does the temperature of Room 2 feel compared to Room 1?”

In addition, a plurality of buttons 1920, 1930, and 1940 for obtaining a user response to the query message 1910 may be provided. The user may input the comparison result of the two spaces' temperatures by using the buttons 1920, 1930, and 1940. For example, the plurality of buttons 1920, 1930, and 1940 may include the first button 1920 indicating that the specific space (Room 2) feels warmer, the second button 1930 indicating that the two spaces feel similar in temperature, and the third button 1940 indicating that the specific space feels cooler. The user response obtained from the first button 1920, the second button 1930, or the third button 1940 may be transmitted to the server 3.

FIG. 20 is a table illustrating weights added to the temperature of the adjacent space based on a user response to the comparison request described in FIG. 19.

Once a user response is obtained through the first button 1920, the second button 1930, or the third button 1940 shown in FIG. 19, the server 3 may generate temperature information for the specific space (Room 2) based on the user response. The server 3 may determine a weight to be added to the temperature of the adjacent space (Room 1) based on the user response. The server 3 may generate the temperature information of the specific space (Room 2) based on the sum of the temperature of the adjacent space (Room 1) and the weight.

For example, referring to a table 2000 of FIG. 20, in a case where a user response is obtained through the first button 1920 indicating that the temperature of the specific space (Room 2) feels higher, the server 3 may add a first weight (e.g., +5° C.) to the temperature of the adjacent space (Room 1). In a case where a user response is obtained through the second button 1930 indicating that the two spaces' temperatures feels similar, the server 3 may add a second weight (e.g., +2° C.) to the temperature of the adjacent space (Room 1). In a case where a user response is obtained through the third button 1940 indicating that the temperature of the specific space (Room 2) feels lower, the server 3 may add a third weight (e.g., −5° C.) to the temperature of the adjacent space (Room 1).

FIG. 21 is a table illustrating weights added to a humidity of an adjacent space based on a user response to a request for comparison between a humidity of a specific space and the adjacent space.

The method of generating temperature information of a specific space described in FIG. 19 and FIG. 20 may be applied in the same manner to generate humidity information of a specific space. A request to compare a humidity of a specific space to a humidity of an adjacent space may be provided as a query message, and humidity information of the specific space may be generated based on a user response to the query message.

For example, referring to a table 2100 of FIG. 21, in a case where a user response is obtained indicating that the specific space (Room 2) feels more humid, the server 3 may add a first humidity weight (e.g., ±12%) to a humidity of the adjacent space (Room 1). In a case where a user response is obtained indicating that the humidities of the two spaces feel similar, the server 3 may add a second humidity weight (e.g., ±5%) to the humidity of the adjacent space (Room 1).

In a case where a user response is obtained indicating that the specific space (Room 2) feels less humid, the server 3 may add a third humidity weight (e.g., −12%) to the humidity of the adjacent space (Room 1).

FIG. 22 illustrates a user interface screen, updated from FIG. 12, after information of the specific space is modified.

Once temperature information or humidity information of the second room S2 is completely modified or obtained by the various methods described in FIG. 15 through FIG. 21, the server 3 may update the map M1 shown in FIG. 12 and the second information window 1240 of the second room S2. FIG. 22 illustrates a user interface screen 2200 including the updated map M1 and the updated second information window 2210. In the updated map M1 and the updated second information window 2210, the temperature of the second room S2 is displayed as 26° C., and the humidity of the second room S2 is displayed as 66%. In addition, to show that the temperature and humidity of the second room S2 are estimated based on a user response, an asterisk (*) may appear for both temperature and humidity in the second information window 2210.

FIG. 23 illustrates an example of a user interface screen that notifies a user of completion of temperature customization for a specific space and requests feedback on a temperature customization result.

As described above, in order to bring each of the plurality of spaces forming the indoor space to the target temperature, the air conditioners 1, arranged in various locations of the indoor space, may be controlled. The server 3 may monitor a temperature of each of the plurality of spaces. The server 3 may identify whether the temperature of each of the plurality of spaces reaches the target temperature based on temperature data obtained by sensors installed in the plurality of spaces or based on a user response.

The server 3 may control the air conditioner 1 or the user device 2 to provide a notification of completion of temperature customization based on a portion or all of the plurality of spaces reaching the target temperature. The completion notification may be provided in text, images, or sound.

For example, as shown in a screen 2300 of FIG. 23, a pop-up window 2310 including a text message such as, “temperature customization for Room 2 is complete. Please check the temperature customization result” may be displayed via the air conditioner 1 or the user device 2. The pop-up window 2310 may also display buttons 2320 and 2330 for obtaining a user response to the temperature customization completion notification.

When the user presses a “check now” button 2320, a screen for inputting feedback on the temperature customization result may be displayed. When the user presses a “remind me later” button 2330, the temperature customization completion notification may be displayed again after a predetermined period of time.

FIG. 24 illustrates an example of a user interface screen for obtaining user feedback on a temperature customization result.

In a case where a user response is obtained through the “check now” button 2320 on the screen 2300 of FIG. 23, the air conditioner 1 or the user device 2 may display a feedback input screen 2400 for the temperature customization result.

The feedback input screen 2400 may include a query message 2410 requesting a comparison between a current temperature of a space and the target temperature, and a plurality of buttons 2420, 2430, and 2440 for obtaining a user response to the query message 2410. The plurality of buttons 2420, 2430, and 2440 may include the first response button 2420 indicating that the current temperature of the space feels higher than the target temperature, the second response button 2430 indicating that the current temperature feels similar to the target temperature, and the third response button 2440 indicating that the current temperature of the space feels lower than the target temperature. The user response obtained from the first response button 2420, the second response button 2430, or the third response button 2440 may be transmitted to the server 3.

The server 3 may determine whether further temperature adjustment for a space is required based on the user response. In a case where the user responds that the space's temperature feels higher or lower than the target temperature after the completion notification is provided, the server 3 may change at least one of the operation mode, the airflow direction, or the airflow speed of the air conditioner 1 in order to bring the space's temperature to the target temperature.

FIG. 25 illustrates an example of a user interface screen for the target space settings for temperature customization shown in FIG. 11.

In a case where a user input is obtained by clicking, touching, or pressing the “target space settings for temperature customization” menu 1120 shown in FIG. 11, a screen 2500 of FIG. 25 may be displayed via the air conditioner 1 or the user device 2.

Referring to FIG. 25, a guide message 2510 guiding a user to select a space for temperature customization may appear, along with a space list TL representing a plurality of spaces. The space list TL may include a plurality of buttons B1, B2, B3, B4, and B5 to set or release each of the plurality of spaces as a target space.

For example, an indoor space may be divided into a living room, a kitchen, a Room 1, a Room 2, and a Room 3. By turning on the first setting button B1, the living room may be set or released as a target space for temperature customization. By turning on the second setting button B2, the kitchen may be set or released as a target space for temperature customization. By turning on the third setting button B3, the Room 1 may be set or released as a target space for temperature customization. By turning on the fourth setting button B4, the Room 2 may be set or released as a target space for temperature customization. By turning on the fifth setting button B5, the Room 3 may be set or released as a target space for temperature customization.

Temperature customization may be performed only for the space set as a target space for temperature customization through the “target space settings for temperature customization” menu 1120, while spaces not set as the target space may be excluded from temperature customization.

A user may select which spaces to designate as the target space for temperature customization, and thus user convenience may be improved.

FIG. 26 illustrates an example of a notification message provided in a case where the first temperature customization mode shown in FIG. 11 is activated.

In a case where a button included in the “first temperature customization mode” menu 1130 is turned on in FIG. 11, the first temperature customization mode may be activated. Once the first temperature customization mode is activated, a pop-up window 2610 including a guide message briefly describing an operation of the first temperature customization mode may be displayed via the air conditioner 1 or the user device 2.

The guide message briefly describing the first temperature customization mode may be provided as a text message such as, “entire indoor space is adjusted to the target temperature, starting with the place where the air conditioner is located.”

As described above, in response to the activation of the first temperature customization mode, the server 3 may transmit a control signal to the air conditioner 1 to first bring a temperature of the space closest to the air conditioner 1 to the target temperature. In a case where a temperature of a first space, which is the closest to the air conditioner 1, has reached the target temperature, the server 3 may transmit a control signal to the air conditioner 1 to bring a temperature of a second space, which is second closest to the air conditioner 1, to the target temperature. The airflow direction and airflow speed of the air conditioner 1 may be adjusted to control the temperature of the second space. By the above method, the temperature of each of the plurality of spaces may be brought to the target temperature sequentially.

FIG. 27 illustrates an example of a notification message provided to notify of an error in temperature customization of a specific space.

Referring to FIG. 27, in a case where an error occurs in customizing a temperature of a specific space among a plurality of spaces, a screen 2700 including a notification message 2710 about the error may be displayed via the air conditioner 1 or the user device 2.

The server 3 may identify whether a temperature of a specific space reaches a target temperature within a first threshold time after the air conditioner 1 starts operating. In a case where the temperature of the specific space does not reach the target temperature within the first threshold time, the server 3 may transmit notification information indicating an occurrence of an error in the temperature adjustment of the space to the air conditioner 1 or the user device 2. The air conditioner 1 or the user device 2 may display the notification message corresponding to the notification information received from the server 3.

For example, the notification message 2710 related to the error in temperature customization may be provided as a text message such as, “temperature customization for Room 2 is not working properly. Please check for objects obstructing the airflow to Room 2.” FIG. 28 illustrates an example of a notification message provided in a case where the second temperature customization mode shown in FIG. 11 is activated.

In a case where a button included in the “second temperature customization mode” menu 1140 is turned on in FIG. 11, the second temperature customization mode may be activated. Once the second temperature customization mode is activated, a pop-up window 2810 including a guide message briefly describing an operation of the second temperature customization mode may be displayed via the air conditioner 1 or the user device 2.

The guide message briefly describing the second temperature customization mode may be provided as a text message such as, “a priority of each space for temperature customization is determined based on the user activity level.”

As described above, in response to the activation of the second temperature customization mode, the server 3 may transmit a control signal to the air conditioner 1 to first bring a temperature of a space having the highest user activity level to the target temperature. In a case where a temperature of a first space having the highest user activity level has reached the target temperature, the server 3 may transmit a control signal to the air conditioner 1 to bring a temperature of a second space having the second-highest user activity level to the target temperature. The airflow direction and airflow speed of the air conditioner 1 may be adjusted to control the temperature of the second space. By the above method, the temperature of each of the plurality of spaces may be brought to the target temperature sequentially.

FIG. 29 illustrates an example of a map provided in a case where the second temperature customization mode shown in FIG. 11 is activated.

Referring to FIG. 29, once the second temperature customization mode is activated, a map M3 including a user activity level for each of the plurality of spaces may be provided. The map M1 in FIG. 12 may be referred to as a “first map,” the map M2 in FIG. 13 may be referred to as a “second map,” and the map M3 in FIG. 29 may be referred to as a “third map.”

For example, the third map M3 may display the plurality of spaces forming the indoor space, and temperature, humidity, and user activity level of each space. The user activity level may be determined using channel state information (CSI) obtained in each of the plurality of spaces.

A user may more easily identify which space requires temperature adjustment by referring to the user activity level of each of the plurality of spaces.

FIG. 30 is a table illustrating criteria for assigning priorities to a plurality of spaces in a case where the second temperature customization mode shown in FIG. 11 is activated.

Referring to a table 3000 of FIG. 30, in the second temperature customization mode, the server 3 may determine a priority of each of the plurality of spaces by using a user activity level of each of the plurality of spaces, obtained in each of the plurality of spaces, as a first determination condition. The server 3 may assign a higher priority to a space having a higher user activity level.

In a case where there is a space for which a user activity level is not obtained or a plurality of spaces have the same user activity level, the server 3 may use another determination condition to determine the priority of each of the plurality of spaces.

For example, the server 3 may use a difference between a current temperature of a space and a target temperature as a second determination condition to determine a priority of each of the plurality of spaces. The larger the difference, the higher the assigned priority.

In addition, the server 3 may use a distance between the air conditioner 1 and each of the plurality of spaces as a third determination condition to determine a priority of each of the plurality of spaces. The closer the distance between the air conditioner 1 and the space, the higher the assigned priority.

FIG. 31 illustrates an example of a user interface screen provided for the target space settings for focused temperature customization shown in FIG. 11.

In a case where a user input is obtained by clicking, touching, or pressing the “target space settings for focused temperature customization” menu 1160 shown in FIG. 11, a screen 3100 of FIG. 31 may be displayed via the air conditioner 1 or the user device 2.

Referring to FIG. 31, a space list FL representing the plurality of spaces may be displayed. The space list FL may include a plurality of buttons FB1, FB2, FB3, FB4, and FB5 to set or release each of the plurality of spaces as a target space for focused temperature customization.

For example, an indoor space may be divided into a living room, a kitchen, a Room 1, a Room 2, and a Room 3. By turning on the first setting button FB1, the living room may be set or released as a target space for focused temperature customization. By turning on the second setting button FB2, the kitchen may be set or released as a target space for focused temperature customization. By turning on the third setting button FB3, the Room 1 may be set or released as a target space for focused temperature customization. By turning on the fourth setting button FB4, the Room 2 may be set or released as a target space for focused temperature customization. By turning on the fifth setting button FB5, the Room 3 may be set or released as a target space for focused temperature customization.

Once the third temperature customization mode is activated, the highest priority may be assigned to the space that a user designates as a target space for focused temperature customization. In a case where a plurality of spaces are designated as target space for focused temperature customization, priorities of the plurality of designated spaces may be determined to be different based on at least one of user activity levels obtained in the spaces or distances between the air conditioner 1 and the spaces.

For example, as shown in FIG. 31, in a case where both the living room and Room 1 are designated as target space for focused temperature customization, the highest priority may be initially assigned to the living room and Room 1. Then, in a case where the user activity level for the living room is higher than that for Room 1, the priority of the living room may be determined higher than that of Room 1.

By assigning a higher priority to the space designated by the user as the target space for focused temperature customization, user convenience may be improved.

According to an embodiment of the disclosure, an electronic device may include: a communication circuit configured to communicate with a map generation device, a temperature sensor, a user device and an air conditioner; and a processor configured to control the communication circuit. The processor may be configured to obtain map data of an indoor space including a plurality of spaces from at least one of the map generation device or the user device. The processor may be configured to obtain temperature information of the plurality of spaces from at least one of the temperature sensor or the user device. The processor may be configured to determine a priority of each of the plurality of spaces for temperature adjustment based on an input for activating a temperature customization mode obtained from the user device. The processor may be configured to control the communication circuit to transmit to the air conditioner a control signal to allow a temperature of each of the plurality of spaces to reach a preset target temperature based on the temperature information of the plurality of spaces and the priority.

The processor may be configured to, based on a failure to obtain temperature information of at least one of the plurality of spaces, control the communication circuit to transmit notification information indicating an omission of temperature information of the at least one of the plurality of spaces to the user device.

The processor may be configured to, based on a failure to obtain temperature information of at least one of the plurality of spaces, transmit a query message for requesting a user for a response related to the at least one space to the user device via the communication circuit, and generate the temperature information of the at least one space based on the user's response to the query message.

The processor may be configured to control the communication circuit to transmit the query message including a request to input a temperature value of the at least one space to the user device, and generate the temperature information of the at least one space based on the temperature value input according to the user's response.

The processor may be configured to control the communication circuit to transmit the query message including a request to confirm a space adjacent to the at least one of the plurality of spaces to the user device, and generate the temperature information of the at least one space based on a temperature of the adjacent space identified according to the user's response.

The processor may be configured to control the communication circuit to transmit to the user device the query message including a request for comparison between a first temperature of a space adjacent to the at least one of the plurality of spaces and a second temperature felt by the user; determine a weight to be added to the first temperature of the adjacent space according to the user's response; and generate the temperature information of the at least one space based on a sum of the first temperature of the adjacent space and the weight.

The processor may be configured to determine a distance between a location of the air conditioner and each of the plurality of spaces in response to the temperature customization mode being activated, and determine the priority in an order from closest to farthest distance between the air conditioner and each of the plurality of spaces.

The processor may be configured to determine an activity level of the user in each of the plurality of spaces based on channel state information obtained in each of the plurality of spaces in response to the temperature customization mode being activated, and determine the priority in descending order of the activity figure.

The processor may be configured to identify a space designated by the user as a temperature adjustment target in response to the temperature customization mode being activated, and assign a highest priority to the designated space.

The processor may be configured to control the communication circuit to transmit to the user device notification information indicating an occurrence of an error in temperature adjustment of at least one of the plurality of spaces, based on a time required for a temperature in the at least one space to reach the target temperature exceeding a threshold time.

The processor may be configured to: based on a time required for a temperature of one space of the plurality of spaces to reach a target temperature for the one space based on the respective temperature information exceeding a threshold time, control the communication circuit to transmit to the air conditioner a control signal to operate the air conditioner so that a temperature of another space among the plurality of spaces, which has a lower priority than the one space, is adjusted toward reaching a target temperature for the another space.

The processor may be configured to control the communication circuit to transmit to the air conditioner a control signal for controlling at least one of an airflow speed or an airflow direction of the air conditioner, based on the temperature of each of the plurality of spaces reaching the target temperature.

According to an embodiment of the disclosure, in a method for controlling an electronic device configured to communicate with a map generation device, a temperature sensor, a user device and an air conditioner, the method may include: obtaining map data of an indoor space including a plurality of spaces from at least one of the map generation device or the user device; obtaining temperature information of the plurality of spaces from at least one of the temperature sensor or the user device; determining a priority of each of the plurality of spaces for temperature adjustment based on an input for activating a temperature customization mode obtained from the user device; and transmitting to the air conditioner a control signal to allow a temperature of each of the plurality of spaces to reach a preset target temperature based on the temperature information of the plurality of spaces and the priority.

The method may further include, based on a failure to obtain temperature information of at least one of the plurality of spaces, transmitting notification information indicating an omission of temperature information of the at least one of the plurality of spaces to the user device.

The obtaining of the temperature information of the plurality of spaces may include: based on a failure to obtain temperature information of at least one of the plurality of spaces, transmitting a query message for requesting a user for a response related to the at least one space to the user device; and generating the temperature information of the at least one space based on the user's response to the query message.

The query message may include a request to input a temperature value of the at least one space. The obtaining of the temperature information of the plurality of spaces may include generating the temperature information of the at least one space based on the temperature value input according to the user's response.

The query message may include a request to confirm a space adjacent to the at least one of the plurality of spaces. The obtaining of the temperature information of the plurality of spaces may include generating the temperature information of the at least one space based on a temperature of the adjacent space identified according to the user's response.

The query message may include a request for comparison between a first temperature of a space adjacent to the at least one of the plurality of spaces and a second temperature felt by the user. The obtaining of the temperature information of the plurality of spaces may include: determining a weight to be added to the first temperature of the adjacent space according to the user's response; and generating the temperature information of the at least one space based on a sum of the first temperature of the adjacent space and the weight.

The determining of the priority of each of the plurality of spaces may include: determining a distance between a location of the air conditioner and each of the plurality of spaces in response to the temperature customization mode being activated; and determining the priority in an order from closest to farthest distance between the air conditioner and each of the plurality of spaces.

The transmitting of the control signal to the air conditioner may include transmitting a control signal for controlling at least one of an airflow speed or an airflow direction of the air conditioner, based on the temperature of each of the plurality of spaces reaching the target temperature.

According to the disclosure, the electronic device, the method for controlling the electronic device, and the system may provide various modes and control various devices to properly adjust a temperature and humidity of a plurality of spaces to suit a user.

According to the disclosure, the electronic device, the method for controlling the electronic device, and the system may selectively and sequentially control a temperature and humidity of a plurality of spaces according to user settings.

According to the disclosure, the electronic device, the method for controlling the electronic device, and the system may, even in a case where temperature information and humidity information of a specific space are not automatically obtained by sensors, estimate the temperature information and humidity information of the space through questions and answers with a user.

Meanwhile, the disclosed embodiments may be implemented in the form of a recording medium that stores instructions executable by a computer. The instructions may be stored in the form of program codes, and when executed by a processor, the instructions may generate a program module to perform operations of the disclosed embodiments.

The machine-readable recording medium may be provided in the form of a non-transitory storage medium. Here, when a storage medium is referred to as “non-transitory,” it may be understood that the storage medium is tangible and does not include a signal (electromagnetic waves), but rather that data is semi-permanently or temporarily stored in the storage medium. For example, a “non-transitory storage medium” may include a buffer in which data is temporarily stored.

The methods according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed through an application store (e.g., Play Store™) online. In the case of online distribution, at least a portion of the computer program product may be stored at least semi-permanently or may be temporarily generated in a storage medium, such as a memory of a server of a manufacturer, a server of an application store, or a relay server.

Although embodiments of the disclosure have been described with reference to the accompanying drawings, a person having ordinary skilled in the art will appreciate that other specific modifications may be easily made without departing from the technical spirit or essential features of the disclosure. Accordingly, the foregoing embodiments should be regarded as illustrative rather than limiting in all aspects.

1. An electronic device, comprising:
a communication circuit configured to communicate with at least one air conditioner;
at least one memory storing instructions; and
at least one processor
wherein at least one instruction from among the instructions that, when executed by at least one processor, causes the electronic device to:
obtain map data of an indoor space including a plurality of spaces from at least one of a map generation device or a user device,
obtain respective temperature information of each space of the plurality of spaces from at least one of a temperature sensor or the user device,
determine a respective priority for temperature adjustment of each space of the plurality of spaces based on an input for activating a temperature customization mode obtained from the user device, and
control the communication circuit to transmit to the at least one air conditioner a control signal to operate each of the at least one air conditioner so that, for each space of the plurality of spaces, a temperature of the space is adjusted toward reaching a target temperature for the space based on the respective temperature information for the space that was obtained and the respective priority for temperature adjustment for the space that was determined.

2. The electronic device of claim 1, wherein the at least one instruction from among the instructions that, when executed by the at least one processor, causes the electronic device further to:
based on a failure to obtain the respective temperature information of at least one space of the plurality of spaces, control the communication circuit to transmit notification information indicating an omission of the respective temperature information of the at least one space to the user device.

3. The electronic device of claim 1, wherein the at least one instruction from among the instructions that, when executed by the at least one processor, causes the electronic device further to:
based on a failure to obtain the respective temperature information of at least one space of the plurality of spaces, control the communication circuit to transmit a query message requesting a user for a response related to the at least one space to the user device, and
based on the response to the transmitted query message, generate the respective temperature information of the at least one space.

4. The electronic device of claim 3, wherein
the query message includes a request to input a temperature value of the at least one space to the user device, and
the at least one instruction from among the instructions that, when executed by the at least one processor, causes the electronic device further to:
based on the temperature value input in response to the request, generate the respective temperature information of the at least one space.

5. The electronic device of claim 3, wherein
the query message includes a request to input a confirmation of a space adjacent to the at least one space of the plurality of spaces to the user device, and
the at least one instruction from among the instructions that, when executed by the at least one processor, causes the electronic device further to:
based on the confirmation of the adjacent space in response to the request and a temperature of the confirmed adjacent space, generate the respective temperature information of the at least one space.

6. The electronic device of claim 3, wherein
the query message includes a request to input, to the user device, a comparison between a first temperature of a space adjacent to the at least one space of the plurality of spaces and a second temperature felt by the user in the at least one space, and
the at least one instruction from among the instructions that, when executed by the at least one processor, causes the electronic device further to:
based on the comparison in response to the request, determine a weight to be added to the first temperature, and
generate the respective temperature information of the at least one space based on a sum of the first temperature and the determined weight.

7. The electronic device of claim 1, wherein
the at least one instruction from among the instructions that, when executed by the at least one processor, causes the electronic device further to:
identify a respective distance between a location of each of the at least one air conditioner and each space of the plurality of spaces in response to the temperature customization mode being activated, and
determine the respective priority in ascending order of the respective distance between the location of the each of the at least one air conditioner and each space of the plurality of spaces that was identified.

8. The electronic device of claim 1, wherein
the at least one instruction from among the instructions that, when executed by the at least one processor, causes the electronic device further to:
identify a respective user activity level in each space of the plurality of spaces based on channel state information obtained in each space of the plurality of spaces in response to the temperature customization mode being activated; and
determine the respective priority in descending order of the respective user activity level that was identified.

9. The electronic device of claim 1, wherein
the at least one instruction from among the instructions that, when executed by the at least one processor, causes the electronic device further to:
identify a space of the plurality of spaces that is designated as a temperature adjustment target in response to the temperature customization mode being activated; and
assign a highest priority to the identified space.

10. The electronic device of claim 1, wherein the at least one instruction from among the instructions that, when executed by the at least one processor, causes the electronic device further to:
based on a time required for a temperature of one space of the plurality of spaces to reach a target temperature for the one space based on the respective temperature information exceeding a threshold time, control the communication circuit to transmit notification information corresponding to the exceeding of the threshold time to the user device.

11. The electronic device of claim 1, wherein the at least one instruction from among the instructions that, when executed by the at least one processor, causes the electronic device further to:
based on a time required for a temperature of one space of the plurality of spaces to reach a target temperature for the one space based on the respective temperature information exceeding a threshold time, control the communication circuit to transmit to the at least one air conditioner a control signal to operate the at least one air conditioner so that a temperature of another space among the plurality of spaces, which has a lower priority than the one space, is adjusted toward reaching a target temperature for the another space.

12. The electronic device of claim 1, wherein the at least one instruction from among the instructions that, when executed by the at least one processor, causes the electronic device further to:
based on a respective temperature of each space of the plurality of spaces reaching a respective target temperature for the space based on the respective temperature information, control the communication circuit to transmit to the at least one air conditioner a control signal for controlling at least one of an airflow speed or an airflow direction of the at least one air conditioner.

13. A method for controlling an electronic device including a communication circuit configured to communicate with at least one air conditioner, and at least one processor, the method comprising:
by the at least one processor,
obtaining map data of an indoor space including a plurality of spaces from at least one of a map generation device or a user device,
obtaining respective temperature information of each space of the plurality of spaces from at least one of a temperature sensor or the user device,
determining a respective priority for temperature adjustment of each space of the plurality of spaces based on an input for activating a temperature customization mode obtained from the user device, and
controlling the communication circuit to transmit to the at least one air conditioner a control signal to operate the at least one air conditioner so that, for each space of the plurality of spaces, a temperature of the space is adjusted toward reaching a target temperature for the space based on the respective temperature information for the space that was obtained and the respective priority for temperature adjustment for the space that was determined.

14. The method of claim 13, further comprises, based on a failure to obtain the respective temperature information of at least one space of the plurality of spaces, controlling the communication circuit to transmit notification information indicating an omission of the respective temperature information of the at least one space to the user device.

15. The method of claim 13, wherein the obtaining respective temperature information includes:
based on a failure to obtain the respective temperature information of at least one space of the plurality of spaces, controlling the communication circuit to transmit a query message requesting a user for a response related to the at least one space to the user device, and
based on the response to the transmitted query message, generating the respective temperature information of the at least one space.

16. The method of claim 15, wherein the query message includes a request to input a confirmation of a space adjacent to the at least one space of the plurality of spaces to the user device, and
wherein the obtaining respective temperature information includes:
based on the confirmation of the adjacent space in response to the request and a temperature of the confirmed adjacent space, generating the respective temperature information of the at least one space.

17. The method of claim 15, wherein the query message includes a request to input, to the user device, a comparison between a first temperature of a space adjacent to the at least one space of the plurality of spaces and a second temperature felt by the user in the at least one space, and
wherein the obtaining respective temperature information includes:
based on the comparison in response to the request, determining a weight to be added to the first temperature; and
generating the respective temperature information of the at least one space based on a sum of the first temperature and the determined weight.

18. The method of claim 13, wherein the determining the respective priority for temperature adjustment includes:
identifying a respective distance between a location of each of the at least one air conditioner and each space of the plurality of spaces in response to the temperature customization mode being activated; and
determining the respective priority in ascending order of the respective distance between the location of the each of the at least one air conditioner and each space of the plurality of spaces that was identified.

19. The method of claim 13, wherein the determining the respective priority for temperature adjustment includes:
identifying a respective user activity level in each space of the plurality of spaces based on channel state information obtained in each space of the plurality of spaces in response to the temperature customization mode being activated; and
determining the respective priority in descending order of the respective user activity level that was identified.

20. The method of claim 13, wherein the controlling the communication circuit includes:
based on a time required for a temperature of one space of the plurality of spaces to reach a target temperature for the one space based on the respective temperature information exceeding a threshold time, controlling the communication circuit to transmit notification information corresponding to the exceeding of the threshold time to the user device.
